(19) United States
(12) Patent Application Publication
(10) Pub. No.: US 2014/0298244 A1
(43) Pub. Date: Oct. 2, 2014

(54) PORTABLE DEVICE USING TOUCH PEN AND APPLICATION CONTROL METHOD USING THE SAME

(71) Applicant: Samsung Electronics Co., Ltd., Suwon-si (KR)

(72) Inventor: Ik-Soo KIM, Seoul (KR)

(73) Assignee: Samsung Electronics Co., Ltd., Suwon-si (KR)

(21) Appl. No.: 14/211,594

(22) Filed: Mar. 14, 2014

(30) Foreign Application Priority Data
Mar. 26, 2013 (KR) 10-2013-0032165

(51) Int. Cl. G06F 3/0482; G06F 3/0488

(52) U.S. Cl. CPC G06F 3/0482; G06F 3/0488
USPC 715/780

(57) ABSTRACT

A method of controlling an application of a portable device using a touch pen and a device supporting the same is provided. The portable device includes a handwriting history list previously input by a user on a memo window provided to be superimposed on a running application. In addition, the portable device detects a user's gesture that selects at least one handwriting history in the handwriting history list and, in response to the user's gesture, controls a function of an application corresponding to the selected handwriting history.

### CROSS-REFERENCE TO RELATED APPLICATION(S)

This application claims the benefit under 35 U.S.C. §119(a) of a Korean patent application filed on Mar. 26, 2013 in the Korean Intellectual Property Office and assigned Serial number 10-2013-0032165, the entire disclosure of which is hereby incorporated by reference.

### TECHNICAL FIELD

The present disclosure relates to a method and a device for controlling a function of an application by recognizing a handwriting image. More particularly, the present disclosure relates to a device and method for controlling a function of a present running application by recognizing a handwriting image input on a touch screen of a portable device.

### BACKGROUND

According to recent increase of portable devices, a demand for User Interfaces (UIs) with intuitive input/output has increased. The UIs have been gradually evolved from a traditional UI method with which information is input using a separate component (e.g., a keyboard, a keypad, a mouse, or the like), to an intuitive method with which information is input by directly touching a screen using a finger or an electronic touch pen or by using a voice, for example.

Nowadays, a user may install various applications in a smart phone which is a representative portable device and use new functions through the installed applications. However, it has not been common that an application installed in a smart phone is interlocked with other applications so as to provide the user with a new function or result. For example, the smart phone has used an input means such as a user's finger, an electronic pen, or the like as an intuitive UI for handwriting a memo in an application that provides a memo function. However, a method of using the memo content input through the intuitive UI in connection with other applications has not been provided.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of controlling an application in a portable device having a touch screen, and in particular, to a method of controlling a function of an application using an intuitive User Interface (UI) for a running application in the portable device.

Another aspect of the present disclosure is to provide a method and a device for controlling a function of an application using a handwriting-based user interface in a portable device.

Another aspect of the present disclosure is to provide a method and a device for controlling a function of an application using a handwriting-based user interface while the application is being executed in a portable device.

Another aspect of the present disclosure is to provide a method and a device for controlling a function of an application using a handwriting history previously input by a user while the application is being executed in the portable device.

In accordance with an aspect of the present disclosure, an application control method of a portable device having a touch screen is provided. The application control method includes displaying an application on the touch screen, providing a memo window including a handwriting input region to be superimposed on the application, detecting a first gesture on the memo window, providing, in response to the detected first gesture, a handwriting history list through the memo window, detecting a second gesture that selects at least one handwriting history in the handwriting history list, and controlling, in response to the detected second gesture, a function of the application corresponding to the selected handwriting history.

In accordance with another aspect of the present disclosure, the providing of the handwriting history list includes providing at least one handwriting image previously input on the memo window and at least one text which is a result of recognizing the at least one handwriting image.

In accordance with another aspect of the present disclosure, the providing of the handwriting history list includes displaying, in response to the first gesture continuously moving in a predetermined direction, the handwriting history list continuously through the memo window in a direction corresponding to the predetermined direction.

In accordance with another aspect of the present disclosure, the application control method further include detecting a user's third gesture that selects at least one handwriting history in the handwriting history list, and deleting, in response to the detected user's third gesture, the at least one handwriting history selected in the handwriting history list.

In accordance with another aspect of the present disclosure, the application control method further includes detecting a user's fourth gesture that selects at least one handwriting history in the handwriting history list, and changing, in response to the detected user's fourth gesture, a position of the at least one handwriting history selected in the handwriting history list.

In accordance with another aspect of the present disclosure, the detecting of the second gesture that selects at least one handwriting history in the handwriting history list includes detecting the second gesture that selects a plurality of handwriting histories in the handwriting history list. The controlling of the function of application corresponding to the selected handwriting history may include controlling, in response to the second gesture, a function of an application corresponding to one handwriting history among the plurality of handwriting histories, and controlling a function of an application corresponding to another handwriting history among the plurality of handwriting histories.

In accordance with another aspect of the present disclosure, the providing of the handwriting history list includes adjusting at least one of a sequence and an interval of the handwriting histories to be displayed on the memo window, and displaying the handwriting histories, of which at least one of the sequence and the interval is adjusted, on the memo window.

In accordance with another aspect of the present disclosure, the providing of the handwriting history list includes providing detailed content of the handwriting images, which correspond to the handwriting images, respectively, through the memo window.

In accordance with another aspect of the present disclosure, the memo window includes a handwriting input infeasible region, and the handwriting input infeasible region displays at least one of a character and an image provided from the application is displayed on the the handwriting input infeasible region.

In accordance with another aspect of the present disclosure, the displaying of the memo window to be superimposed on the application includes displaying the memo window to be superimposed on the application in response to a gesture moving in a direction from an edge of the touch screen to a center of the touch screen.

In accordance with another aspect of the present disclosure, an application control method of a portable device having a touch screen, in which the application control method is provided. The application control method includes displaying an application on the touch screen, providing a memo window which is provided on the touch screen to be superimposed on the application and which includes a handwriting input region, receiving an input of a handwriting image at the handwriting input region on the memo window, providing a handwriting history list which has been previously input and has the input handwriting image as a part thereof, through the memo window, detecting a second gesture that selects at least one handwriting history in the handwriting history list, and controlling, in response to the detected second gesture, a function of the application corresponding to the selected handwriting history.

In accordance with another aspect of the present disclosure, an application control method of a portable device having a touch screen in which the application control method is provided. The application control method includes displaying an application on the touch screen, providing a memo window which is provided to be superimposed on the application and includes a handwriting input region, detecting a predetermined first gesture on the memo window, displaying, in response to the detected first gesture, a handwriting history list through the memo window, and automatically controlling a function of the application corresponding to the displayed handwriting history if an additional user input is not detected on the touch screen for a predetermined length of time.

In accordance with another aspect of the present disclosure, a portable device is provided. The portable device includes a storage unit configured to store a handwriting history list input to a memo window provided to be superimposed on an application, a touch screen configured to, in response to a predetermined first gesture on the memo window provided to be superimposed on the application when the application is executed again, display the handwriting history list stored in the storage unit, and to detect a second gesture that selects at least one handwriting history in the handwriting history list, and a control unit configured to, in response to the detected second gesture, control a function of the application corresponding to the selected handwriting history.

In accordance with another aspect of the present disclosure, the touch screen is further configured to display the handwriting history list by displaying at least one handwriting image previously input on the memo window or at least one text which is a result of recognizing the at least one handwriting image.

In accordance with another aspect of the present disclosure, the touch screen is further configured to, in response to the first gesture continuously moving in a predetermined direction, display the handwriting history list continuously in a direction corresponding to the predetermined direction through the memo window when displaying the handwriting history list.

In accordance with another aspect of the present disclosure, the touch screen is further configured to detect a user's third gesture that selects at least one handwriting history in the handwriting history list, and the control unit is further configured to delete, in response to the detected user's third gesture, the at least one handwriting history selected in the handwriting history list.

In accordance with another aspect of the present disclosure, the touch screen is further configured to detect a user's fourth gesture that selects at least one handwriting history in the handwriting history list, and the control unit is further configured to, in response to the detected user's fourth gesture, change a position of the handwriting history selected in the handwriting history list.

In accordance with another aspect of the present disclosure, the touch screen is further configured to detect a second gesture that selects a plurality of handwriting histories in the handwriting history list, and the control unit is further configured to, in response to the detected second gesture, control a function of an application corresponding to one handwriting history among the plurality of handwriting histories and to control a function of an application corresponding to another handwriting history among the plurality of handwriting histories.

In accordance with another aspect of the present disclosure, a portable device is provided. The portable device includes a storage unit configured to store a handwriting history list input to a memo window provided to be superimposed on an application, a touch screen configured to, when the application is executed again, in response to a handwriting image input on the memo window provided to be superimposed on the application, display a previously input handwriting history list having the handwriting image input through the memo window as a part thereof, and to detect a second gesture that selects at least one handwriting history in the handwriting history list, and a control unit configured to, in response to the detected second gesture, control a function of the application corresponding to the selected handwriting history.

In accordance with another aspect of the present disclosure, a portable device is provided. The portable device includes a storage unit configured to store handwriting images input through a memo window provided to be superimposed on a running application, a touch screen configured to, when the application is executed again, in response to a predetermined first gesture on the memo window provided to be superimposed on the application, display the handwriting images stored in the storage unit on the memo window, and a control unit configured to automatically control a function of the application corresponding to the displayed handwriting image if the portable terminal does not detect a user input for a predetermined length of time.

In accordance with another aspect of the present disclosure, a non-transitory computer readable storage medium storing an application control program is provided. The program includes displaying an application on the touch screen, providing a memo window including a handwriting input region to be superimposed on the application, detecting a first gesture on the memo window, providing, in response to the detected first gesture, a handwriting history list through the memo window, detecting a second gesture that selects at least one handwriting history in the handwriting history list, controlling, in response to the detected second gesture, a function of the application corresponding to the selected handwriting history.

In accordance with another aspect of the present disclosure, a non-transitory computer readable storage medium storing an application control program is provided. The program includes displaying an application on the touch screen, providing a memo window which is provided on the touch screen to be superimposed on the application and which includes a handwriting input region, receiving an input of a handwriting image at the handwriting input region on the memo window, providing a handwriting history list which has been previously input and has the input handwriting image as a part thereof, through the memo window, detecting a second gesture that selects at least one handwriting history in the handwriting history list, and controlling, in response to the detected second gesture, a function of the application corresponding to the selected handwriting history.

In accordance with another aspect of the present disclosure, a non-transitory computer readable storage medium storing an application control program is provided. The program includes providing a memo window which is provided to be superimposed on the application and includes a handwriting input region, detecting a predetermined first gesture on the memo window, displaying, in response to the detected first gesture, a handwriting history list through the memo window, and automatically controlling a function of the application corresponding to the displayed handwriting history if an additional user input is not detected on the touch screen for a predetermined length of time.

In accordance with another aspect of the present disclosure, the portable device provides a handwriting history of a handwriting image previously input by a user, thereby allowing the user to control a function of an application rapidly and intuitively. In particular, the portable device provides a handwriting history while an application is being executed, thereby allowing the user to control a function associated with a currently running application rapidly and intuitively.

In addition, other effects obtained or expected by various embodiments of the present disclosure will be directly or implicitly disclosed in the detailed description of the various embodiments of the present disclosure. For example, various effects expected by the various embodiments of the present disclosure will be disclosed in the detailed description discussed below.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a handwriting input system according to an embodiment of the present disclosure;

FIG. 2 illustrates a configuration of a portable device according to an embodiment of the present disclosure;

FIG. 3 illustrates a configuration of a handwriting recognition unit according to an embodiment of the present disclosure;

FIG. 4 illustrates a flowchart for describing an application control method of a portable device according to an embodiment of the present disclosure;

FIGS. 5A and 5B illustrate an example of controlling a function of an application using a memo window according to an embodiment of the present disclosure;

FIG. 6 illustrates a flowchart for describing an application control method of a portable device according to an embodiment of the present disclosure;

FIGS. 7A and 7B illustrate an example of controlling a function of an application using a handwriting history on a memo widow according to an embodiment of the present disclosure;

FIGS. 8A and 8B illustrate an example of controlling a function of an application using a handwriting history on a memo window according to an embodiment of the present disclosure;

FIGS. 9A and 9B illustrate an example of controlling a function of an application using a handwriting history on a memo window according to an embodiment of the present disclosure;

FIGS. 10A and 10B illustrate an example of controlling a function of an application using a handwriting history on a memo window according to an embodiment of the present disclosure;

FIGS. 11A and 11B illustrate an example of controlling a function of an application using a handwriting history on a memo window according to an embodiment of the present disclosure;

FIG. 12 illustrates an example of deleting at least one of handwriting histories displayed on a memo window according to an embodiment of the present disclosure;

FIG. 13 illustrates an example of bookmarking at least one of handwriting histories displayed on a memo window according to an embodiment of the present disclosure;

FIGS. 14A and 14B illustrate an example of controlling a function of an application using a plurality of handwriting histories on a memo window according to an embodiment of the present disclosure;

FIGS. 15A and 15B illustrate an example of controlling a function of an e-book application using a handwriting history on a memo window according to an embodiment of the present disclosure;

FIGS. 16A and 16B illustrate an example of controlling a function of a search application using a handwriting history on a memo window according to an embodiment of the present disclosure;

FIG. 17 illustrates an example of a memo window according to an embodiment of the present disclosure;

FIG. 18 illustrates a flowchart for describing an application control method of a portable device according to an embodiment of the present disclosure; and

FIG. 19 illustrates a flowchart for describing an application control method of a portable device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some configuration elements may be exaggerated, omitted, or schematically shown, and a size of each element may not precisely reflect the actual size. Accordingly, the present disclosure is not restricted by a relative size or interval shown in the accompanying drawings.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

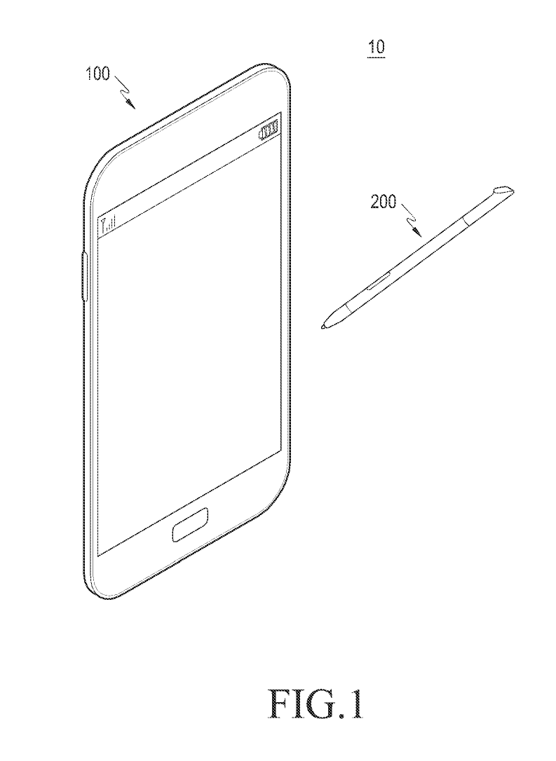

FIG. 1 is a view illustrating a handwriting input system according to an embodiment of the present disclosure.

Referring to FIG. 1, a handwriting input system 10 may include a portable device 100 and a touch pen 200. In the input handwriting input system 10, a user may input a handwriting image on a screen of the portable device 100 while the user is gripping the touch pen 200. As for the handwriting input system 10, an example of a configuration according to an embodiment of the present disclosure is illustrated. However, a configuration for other functions may be additionally provided.

According to various embodiments of the present disclosure, the portable device 100 may be an electronic device.

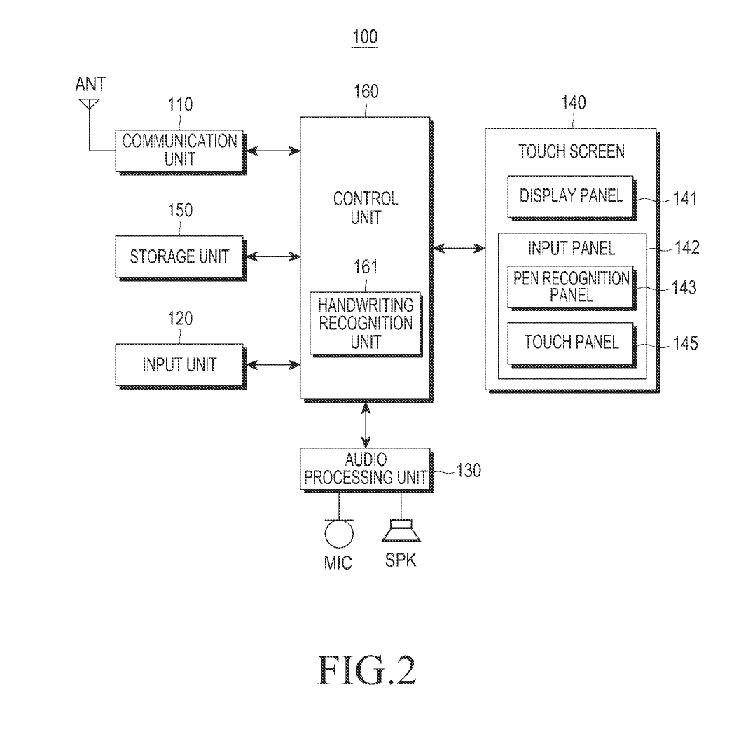

FIG. 2 is a view illustrating a configuration of a portable device according to an embodiment of the present disclosure.

Referring to FIG. 2, according to various embodiments of the present disclosure, the portable device 100 may include a communication unit 110, an input unit 120, an audio processing unit 130, a touch screen 140, a storage unit 150, and a control unit 160.

The touch screen 140 may include a display panel 141 that performs a display function for outputting information output from the portable device 100 and an input panel 142 that performs various input functions by the user.

The display panel 141 may be a panel such as a Liquid Crystal Display (LCD), an Active-Matrix Organic Light-Emitting Diode (AMOLED), and/or the like. The display panel 141 may display various screens according to various operation states of the portable device 100, execution of an application, a service, and/or the like. According to various embodiments of the present disclosure, the display panel 141 may display a running application, a memo window superimposed on the running application, and/or the like.

According to various embodiments of the present disclosure, the input panel 142 may be implemented by at least one panel which may detect the various user inputs that may be input using various objects such as, for example, a finger, a pen, and/or the like. The user input may be a single-touch input, a multi-touch input, a drag input, a handwriting input, a drawing input, or the like. For example, the input panel 142 may be implemented using a single panel which may detect a finger input and a pen input, or implemented using a plurality of panels (e.g., two panels) such as a touch panel 145 that may detect a finger input and a pen recognition panel 143 that may detect a pen input. Hereinafter, according to various embodiments of the present disclosure, a case in which the input panel 142 is implemented by two panels (e.g., the touch panel 145 that may detect a finger input and the pen recognition panel 143 that may detect a pen input) will be described as an example.

According to various embodiments of the present disclosure, the touch panel 145 may detect the user touch input. The touch panel 145 may take a form of, for example, a touch film, a touch sheet, a touch pad, and/or the like. The touch panel 145 detects a touch input and outputs a touch event value corresponding to the detected touch signal. Information corresponding to the touch signal detected at this time may be displayed on the display panel 141. The touch panel 145 may receive an input of an operation signal by the user touch signal by various input means. For example, the touch panel 145 may detect a touch input by various means including the user's body (e.g., fingers, and/or the like), a physical instrument, and/or the like. According to various embodiments of the present disclosure, the touch panel 145 may be configured by a capacitive touch panel.

If the touch panel 145 is configured by the capacitive touch panel, the touch panel 145 may be formed by coating a thin metallic conductive material (e.g., Indium Tin Oxide (ITO)) on both sides of a glass so that a current may flow on the surfaces of the glass, and coating a dielectric material that may store charges. When an object touches the surface of the touch panel 145, a predetermined quantity of charges move to the touched position by static electricity, and the touch panel 145 detects the touched position by recognizing a change amount of the current according to the movement of the charges and pursues a touch event. The touch event generated in the touch panel 145 may be produced mainly by a human finger (e.g., the user). However, the touch event may also be produced by other object of a conductive material which may cause a change in capacitance.

According to various embodiments of the present disclosure, the pen recognition panel 143 detects a proximity input or a touch input of a pen according to operation of a touch pen 200 (e.g., a stylus pen or a digitizer pen) and outputs a detected pen proximity event or a pen touch event. Such a pen recognition panel 143 may be implemented in an EMR type and may detect a touch or proximity input according to a change of intensity of an electromagnetic field. Specifically, the pen recognition panel 143 may include an electromagnetic induction coil sensor (not illustrated) in which a plurality of loop coils are arranged in a first predetermined direction and a second direction that intersects the first direction respectively to form a grid structure, and an electromagnetic signal processing unit (not illustrated) that provides an alternating current signal to each of the loop coils in sequence. When a pen having a resonance circuit therein exists in the vicinity of the loop coils of the pen recognition panel 143, a magnetic field transmitted from the loop coils generates an electric current in the resonance circuit within the pen based on mutual electromagnetic induction. On the basis of this electric current, an induction magnetic field is generated from a coil that forms the resonance circuit in the pen, and the pen recognition panel 143 detects the induction magnetic field at the loop coils which are in a signal receiving state. Thus, a proximity position or a touch position of the pen is detected. With any object capable of generating electric current based on electromagnetic induction, the proximity and touch may be detected through the pen recognition panel 143. According to various embodiments of the present disclosure, it is described that the pen recognition panel 143 is used for recognizing pen proximity and pen touch. Such a pen recognition panel 143 is disposed at a predetermined position in a terminal and may have an activated state according to occurrence of a specific event or by default. In addition, the pen recognition panel 143 may be provided to have an area which may cover a predetermined area at a lower portion of the display panel 141, for example, a display region of the display panel.

According to various embodiments of the present disclosure, the communication unit 110 is a component which may be included when the portable device 100 supports a communication function. In particular, when the portable device 100 supports a mobile communication function, the communication unit 110 may be configured as a mobile communication module. The communication unit 110 may perform specific functions of the portable device 100 that require the communication function, for example, a chatting function, a message transmitting/receiving function, a communication function, and/or the like.

According to various embodiments of the present disclosure, the input unit 120 may be configured by a side key, a separately provided touch pad, and/or the like. In addition, the input unit 120 may include a button key for executing turn-on or turn-off of the portable device 100, a home key that supports returning to a basic screen supported by the portable device 100, and/or the like.

According to various embodiments of the present disclosure, the audio processing unit 130 may include at least one of a speaker for outputting audio signals of the portable device 100 and a microphone for collecting audio signals. In addition, the audio processing unit 130 may control a vibration module so as to control the adjustment of the vibration magnitude of the vibration module. For example, the audio processing unit 130 may change the vibration magnitude depending on a gesture input operation. As an example, when gesture recognition information items are different from each other, the audio processing unit 130 may control the vibration module to have vibration magnitudes corresponding to the gesture recognition information items, respectively.

According to various embodiments of the present disclosure, the storage unit 150 may be configured to store various programs and data required for operating the portable device 100. For example, the storage unit 150 may store an operation system and/or the like required for operating the portable device 100 and may store function programs for supporting screens output on the display panel 141 described above. In addition, the storage unit 150 may store handwriting images that are input by a user on the memo window provided to be superimposed on an application.

According to various embodiments of the present disclosure, the control unit 160 may include various components for controlling an application in a portable device having a touch screen according to various embodiments of the present disclosure and may control signal processing, data processing and function operation for controlling the function of the application based on the components. For example, the control unit 160 may cause the memo window to be displayed to be superimposed on a running application, and may provide a handwriting history stored in the storage unit 150 on the memo window according to a user gesture. In addition, the control unit 160 may execute a control such that the function of an application corresponding to the handwriting history may be performed in response to the user gesture that selects the handwriting history. Meanwhile, the control unit 160 may further include a handwriting recognition unit 161 that recognizes a handwriting image input on the memo window.

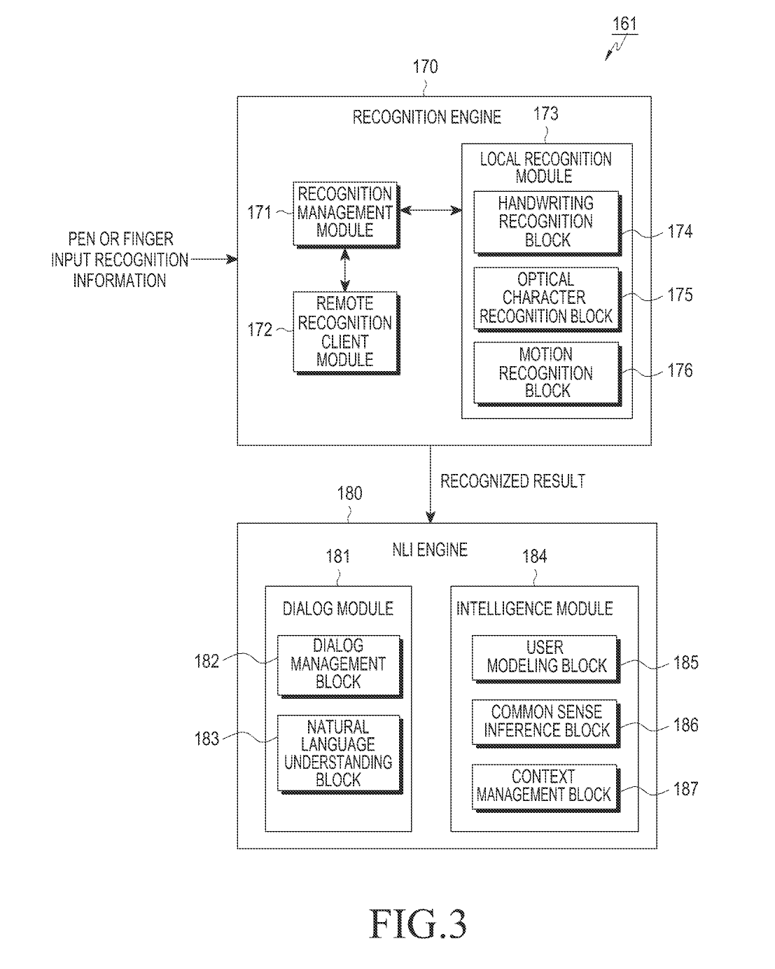

FIG. 3 is a view illustrating a configuration of a handwriting recognition unit according to an embodiment of the present disclosure.

Referring to FIG. 3, a handwriting recognition unit 161 may include a recognition engine 170 and a Natural Language Interaction (NLI) engine 180.

The handwriting recognition unit 161 may use a handwriting image input by a touch pen, a user's fingers, and/or the like on the memo window as input information.

The recognition engine 170 may include a recognition manager module 171, a remote recognition client module 172, and a local recognition module 173. The recognition manager module 171 may be configured to process overall control for outputting a result recognized from the input information. The local recognition module 173 may be configured to recognize input information. The remote recognition client module 172 may be configured to transmit a handwriting image input to the pen recognition panel 143 to a server (not illustrated) so as to recognize the handwriting image and receive a text, which is a result of recognizing the handwriting image, from the server.

The local recognition module 173 may be configured to include a handwriting recognition block 174, an optical character recognition block 175, and a motion recognition block 176. The handwriting recognition block 174 may recognize information input based on a handwriting image. For example, the handwriting recognition block 174 may recognize content written by a pen 200 on the memo window. Specifically, the handwriting recognition block 174 may receive an input of coordinate values of points touched on the pen recognition panel 143, store the coordinate values of the touched points as strokes, and produce a stroke array using the strokes. In addition, the handwriting recognition block 174 may recognize the handwriting image using a handwriting library and a list of the produced stroke array. The optical character recognition block 175 may recognize optical characters by receiving an input of optical signals detected by an optical sensing module and output a recognition result value. The motion recognition block 176 may recognize a motion by receiving an input of a motion sensing signal detected by the motion sensing module and output a motion recognition result value.

The NLI engine 180 may determine the user's intention through the analysis for the recognition result provided from the recognition engine 170. Alternatively, the NLI engine 180 may additionally collect the user's intention through a question and answer session with the user (e.g., by prompting the user to answer at least one inquiry) and determine the user's intention based on the collected information. The NLI engine 180 may include a dialog module 181 and an intelligence module 184. The dialog module 181 may be configured to include a dialog management block 182 that controls dialog flow, and a natural language understanding block 183 that determines the user's intention. The intelligence module 184 may be configured to include a user modeling block 185 that reflects the user's preference, a common sense inference block that reflects a general common sense 186, and a context management block 187 that reflects the user's situation. The dialog module 181 may configure a question for dialog with the user and deliver the configured question to the user to control the flow of the question and answer session for receiving an answer from the user. The dialog management block 182 of the dialog module 181 manages information acquired through the question and answer session. In addition, the natural language understanding block 183 of the dialog block 181 may determine the user's intention by performing natural language processing targeting the information managed by the dialog management block 182.

The intelligence module 184 produces information to be referred to so as to grasp the user's intention through the natural language processing and provides the information to the dialog module 181. For example, the user modeling block 185 of the intelligence module 184 may model information that reflects the user's preference by analyzing the user's habit and/or the like at the time of memo. Further, the common sense inference block 186 of the intelligence module 184 may infer information for reflecting general common sense and the context management block 187 of the intelligence module 184 may manage information that considers the user's current situation. Accordingly, the dialog module 181 of the NLI engine 180 may control the flow of dialog according to a question and answer procedure with the user with the aid of the information provided from the intelligence module 184.

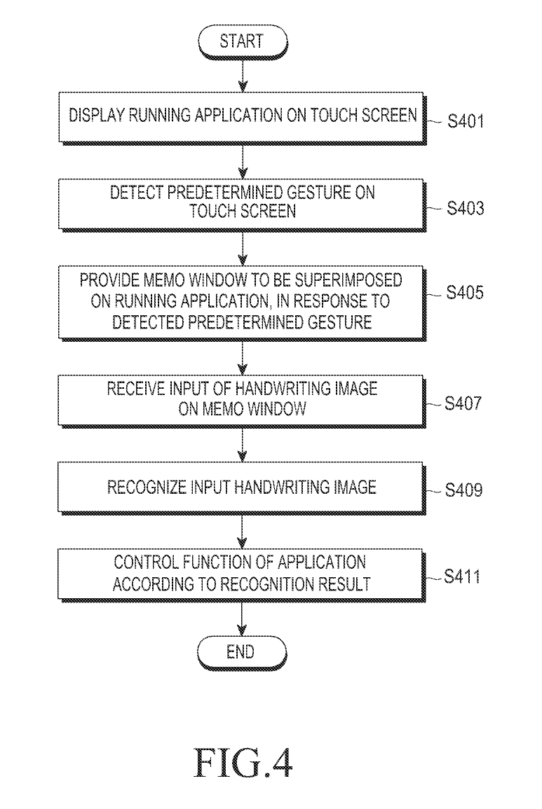

FIG. 4 is a flowchart for describing an application control method of a portable device according to an embodiment of the present disclosure.

Referring to FIG. 4, at operation S401, the portable device 100 may display a running application through the display panel 141 of the touch screen 140. According to various embodiments of the present disclosure, the running application may be, for example, a memo application, a search application, a schedule application, an e-book application, and/or the like.

At operation S403, the portable device 100 may detect the user's predetermined gesture. For example, the portable device 100 may detect the user's predetermined gesture through the input panel 142 of the touch screen 140. According to various embodiments of the present disclosure, the user's predetermined gesture may be a touch drag gesture of dragging from a side of the touch screen 140 toward a center. The touch drag gesture is a gesture of moving a touch pen, a finger, and/or the like in a predetermined direction in a state in which the touch pen, the finger, and/or the like is touched on the touch screen 140. The tough drag gesture may include gestures of, for example, touch and drag, flick, swipe, and/or the like. The touched state refers to a state in which the portable device 100 detects that the touch pen, the finger, and/or the like is touched onto the touch screen. For example, when the touch pen or the finger approaches to the touch screen 140 very closely even if the touch pen or the finger is not touched onto the touch screen 140, the portable device 100 may detect that the touch pen or the finger is touched onto the touch screen 140.

At operation S405, the portable device 100 may provide a memo window to be superimposed on the running application in response to the user's predetermined gesture. According to various embodiments of the present disclosure, the memo window may be displayed on the touch screen 140 in a transparent, semitransparent, or opaque form.

At operation S407, the portable device 100 may receive an input of the user's handwriting image on the memo window. For example, the portable device 100 may receive an input of the user's handwriting image on the memo window through the input panel 142 of the touch screen 140. According to various embodiments of the present disclosure, the handwriting image may be input by the user using the touch pen.

At operation S409, the portable device 100 may recognize the input handwriting image. For example, the portable device 100 may recognize the input handwriting image through the handwriting recognition unit 161 of the control unit 160. For example, when the user inputs the handwriting image using the touch pen, the pen recognition panel 143 of the touch screen 140 may convert the handwriting image into a stroke form and provide the converted value to the handwriting recognition unit 161. The handwriting recognition unit 161 may analyze the input stroke value to produce a text according to the handwriting image.

At operation S411, the application may be controlled according to the recognition result. For example, the control unit 160 of the portable device 100 may control the function of an application, which is running using a text as an input value, according to the result of recognizing the handwriting by the image handwriting recognition unit 161.

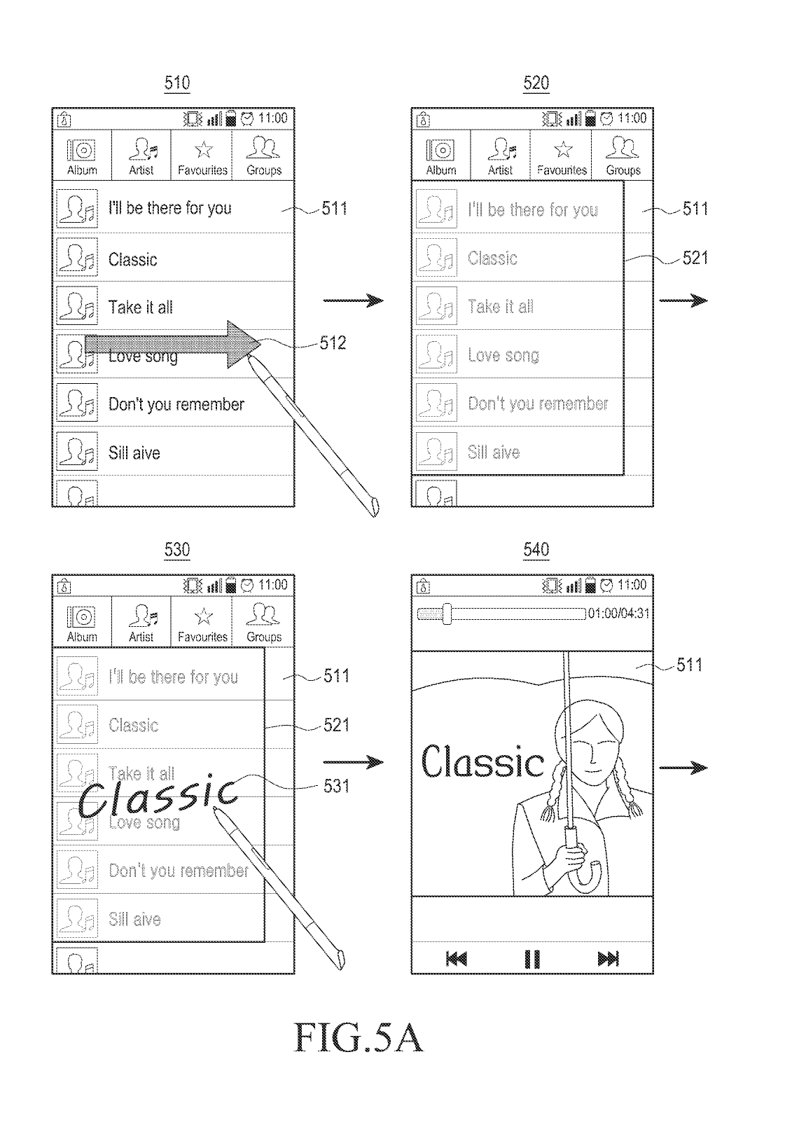

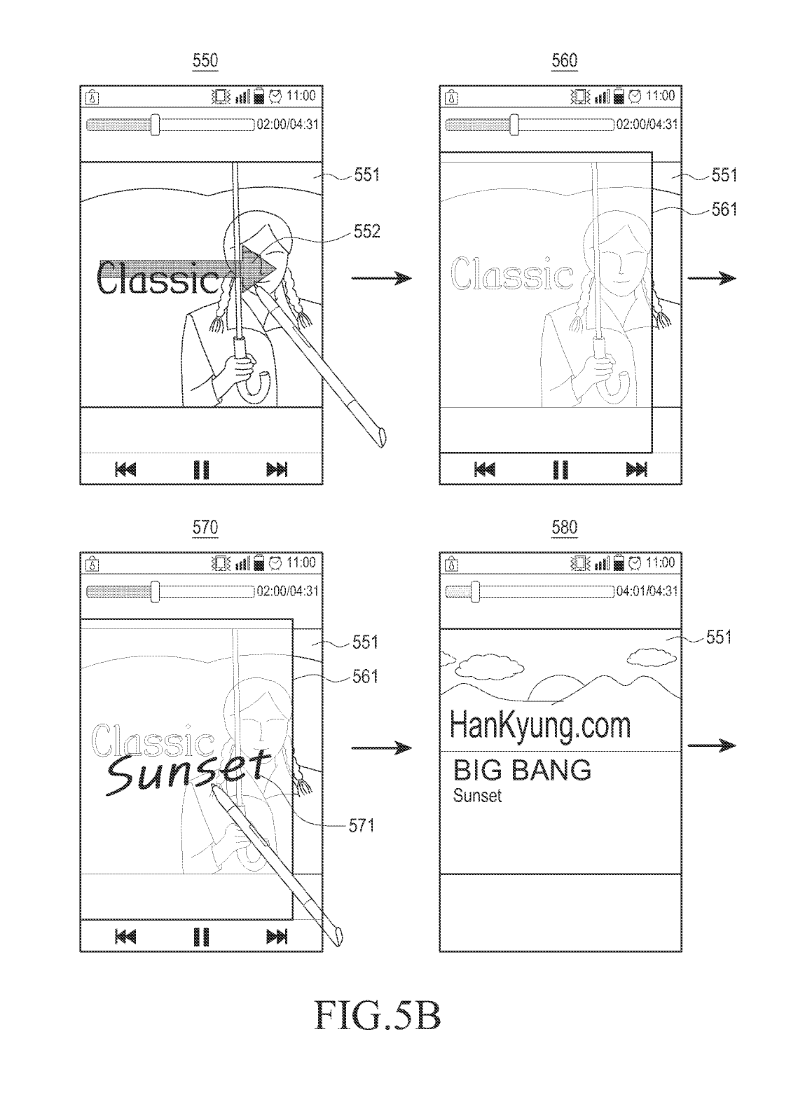

FIGS. 5A and 5B illustrate an example of controlling a function of an application using a memo window according to an embodiment of the present disclosure.

Referring to FIG. 5A, in the operation indicated by reference numeral 510, the portable device 100 may display a music application 511 on the touch screen 140 as a running application. In addition, the portable device 100 may detect a touch drag gesture 512 using a touch pen as a predetermined gesture on the touch screen 140.

In the operation indicated by reference numeral 520, the portable device 100 may provide a memo window 521 to be superimposed on the music application 511 in response to the detected touch drag gesture 512. According to various embodiments of the present disclosure, the memo window 521 may be displayed semi-transparently.

In the operation indicated by reference numeral 530, the portable device 100 may receive an input of a handwriting image 531 related to a music title that the user desires to reproduce using the touch pen on the memo window 521 which is superimposed on the music application 511. Next, the portable device 100 may recognize the input handwriting image 531 and convert the input handwriting image 531 into a text.

In the operation indicated by reference numeral 540, the portable device 100 may search for a music corresponding to the converted text from the music list of the running music application and reproduce the searched-for music through the music application.

Referring to FIG. 5B, in the operation indicated by reference numeral 550, the portable device 100 may detect a touch drag gesture 552 using the touch pen as the predetermined gesture when a music application 551, which is in the process of reproducing a first music, is displayed on the touch screen 140.

In the operation indicated by reference numeral 560, in response to the detected touch drag gesture 552, the portable device 100 may provide a memo window 561 to be superimposed on the music application 551 that provides the first music.

In the operation indicated by reference numeral 570, the portable device 100 may receive an input of a handwriting image 571 related to a title of a second music which is different from the first music that the user desires to reproduce by the touch pen on the memo window 561 which is superimposed on the music application 551. In addition, the portable device 100 may recognize the input handwriting image 571 and convert the input handwriting image 571 into a text.

In the operation indicated by reference numeral 580, while reproducing the first music, the portable device 100 may search for the second music corresponding to the text converted in the music list of the music application 551 and reproduce the searched-for second music.

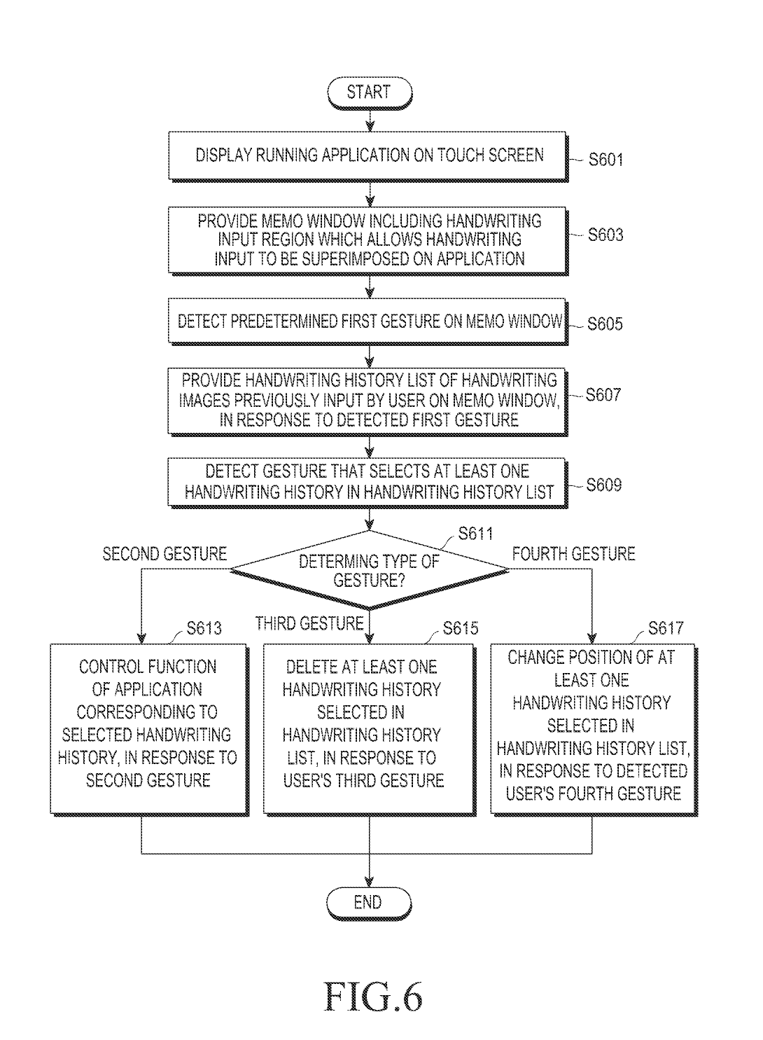

FIG. 6 illustrates a flowchart for describing an application control method of a portable device according to an embodiment of the present disclosure.

Referring to FIG. 6, at operation S601, the portable device 100 may display a running application. For example, the portable device 100 may display a running application through the display panel 141 of the touch screen 140.

At operation S603, the portable device 100 may provide a memo window including a handwriting input region in which a handwriting input may be made to be superimposed on the running application. According to various embodiments of the present disclosure, a memo window may be provided when the user's touch drag gesture of performing touch drag from a side of the touch screen 140 toward the center thereof as illustrated in FIGS. 5A and 5B.

At operation S605, the portable device 100 may detect the predetermined first gesture on the memo window. For example, the portable device 100 may detect the predetermined first gesture on the memo window through the input panel 142 of the touch screen 140. For example, the predetermined first gesture may be a gesture of performing a touch drag in the vertical or horizontal direction on the touch screen 140.

At operation S607, in response to the detected first gesture, the portable device 100 may provide a handwriting history list which has been input on the memo window previously by the user through the display panel 141. For example, referring to FIGS. 5A and 5B, the handwriting images which have been input previously by the user on the memo window may be music titles. The handwriting images may be handwriting images which were executed prior to the time of executing the above-described application and input through the memo window by the user.

The handwriting images previously input by the user may be stored in the storage unit 150 of the portable device 100. According to various embodiments of the present disclosure, the storage unit 150 of the portable device 100 may be stored with a handwriting image, a handwriting recognition result in the form of a text which is a result obtained by recognizing the handwriting image, a handwriting recognition time which is the time when the handwriting image was prepared, and executed application information at the time of preparing handwriting image. Table 1 below illustrates an example of a table of handwriting images stored in the storage unit 150 of the portable device 100.

TABLE 1

| | Handwriting | Handwriting | |
|---|---|---|---|
| Handwriting | Recognition | Recognition | Executed |
| Image | Result | Time | Application |
| [symbol] | Aloe | 5.2 19:00 | Music Application |
| [symbol] | Hello | 6.3 11:00 | Music Application |
| [symbol] | Classic | 6.3 15:00 | Music Application |
| [symbol] | Sunset | 6.9 18:00 | Music Application |
| [symbol] | Arriving | 1.3 14:00 | E-book |
| | | | Application |
| [symbol] | 57p | 1.3 19:00 | E-book |
| | | | Application |
| [symbol] | BookMark1 | 1.6 20:00 | E-book |
| | | | Application |
| [symbol] | Naroho | 9.3 02:00 | Search |
| | | | Application |
| [symbol] | Bear | 9.4 03:00 | Search |
| | | | Application |
| [symbol] | Tiger | 9.4 18:00 | Search |
| | | | Application |

In the handwriting image table, values of respective handwriting images, handwriting recognition results, handwriting recognition times, and applications are included. However, the values may take a form of a link or an indicator.

The handwriting history list may include at least one handwriting history. The handwriting history may be a handwriting image previously input by the user through the memo window or a text which is a recognition result of the handwriting image. The portable device 100 may provide the handwriting history list through the memo window. According to various embodiments of the present disclosure, the portable device 100 may provide detailed contents related to the handwriting images (e.g., handwriting recognition times, applications executed when preparing the handwriting images, or the like) together with the handwriting history.

When the handwriting history list is provided on the memo window, some of the handwriting histories or only one handwriting history on the memo window may be displayed. In addition, the remaining handwriting histories may be sequentially displayed on the memo window through the user's gestures. For example, the portable device 100 may continuously display at least one handwriting image or a text which is the result of recognizing the handwriting image in the vertical or horizontal direction corresponding to the direction of the user's first gesture that moves continuously in the vertical or horizontal direction.

According to various embodiments of the present disclosure, when a plurality of handwriting histories are displayed on the memo window among the handwriting history lists, the plurality of handwriting histories may be displayed in a state in which the intervals thereof are adjusted. For example, when displaying the plurality of handwriting images on the memo window, the portable device 100 may calculate the height or width of each of the handwriting images and then cause the plurality of handwriting images to be displayed in a state in which the plurality of handwriting images are arranged horizontally or vertically at regular intervals.

At operation S609, a gesture that selects at least one handwriting history in the handwriting history list is detected. For example, the input panel 142 of the portable device 100 may detect the user's gesture that selects at least one handwriting history in the handwriting history list. For example, when the plurality of handwriting histories are displayed on the memo window, the portable device 100 may detect the user's gesture that selects one of the plurality of handwriting histories.

At operation S611, the type of gesture is determined. For example, the control unit 160 of the portable device 100 may determine the type of the detected gesture.

According to various embodiments of the present disclosure, when the type of gesture is determined to be a gesture that draws an underline below the handwriting history displayed on the memo window, the control unit 160 may determine the gesture corresponds to a second gesture.

According to various embodiments of the present disclosure, when the type of gesture is a gesture that draws a cancel line on the handwriting history displayed on the memo window, the control unit 160 may determine the gesture corresponds to a third gesture.

According to various embodiments of the present disclosure, when the type of gesture is a gesture that draws a closed loop around the handwriting history displayed on the memo window, the control unit 160 may determine the gesture corresponds to a fourth gesture.

If the control unit 160 determines that the type of the gesture corresponds to the second gesture at operation S611, then the control unit 160 of the portable device 100 may proceed to operation S613 at which the control unit 160 may control the function of the application corresponding to the selected handwriting history in response to the second gesture. For example, if the application is a music application and the handwriting history is a music title, then the portable device 100 may apply the music title selected by the second gesture to the music application as an input value so as to reproduce a sound source related to the music title.

If the control unit 160 determines that the type of the gesture corresponds to the third gesture at operation S611, then the control unit 160 of the portable device 100 may proceed to operation S615 at which the control unit 160 may delete at least one handwriting history selected from the handwriting history list in response to the third gesture. For example, the control unit 160 may display only the remaining handwriting histories with the exception of the deleted handwriting history among the plurality of handwriting histories on the memo window. Further, even when the control unit 160 displays a handwriting history again on the memo window later, only the remaining handwriting histories with the exception of the deleted handwriting history may be displayed on the memo window.

If the control unit 160 determines that the type of the gesture corresponds to the fourth gesture at operation S611, then the control unit 160 of the portable device 100 may proceed to operation S617 at which the control unit 160 may change the position of at least one handwriting history selected from the handwriting history list in response to the fourth gesture. For example, the control unit 160 may move the position of the handwriting history selected from the plurality of handwriting histories to the position of the most recently handwritten history. As a result, the user may be rapidly provided with a frequently used handwriting history through the memo window.

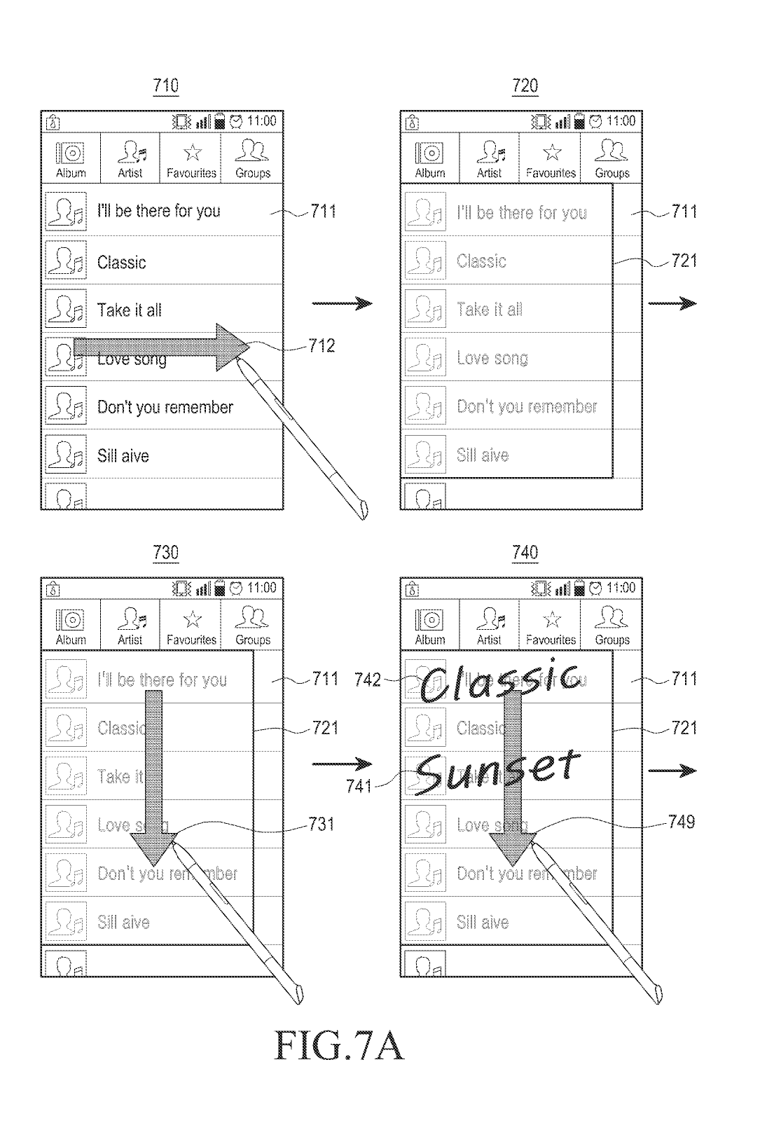

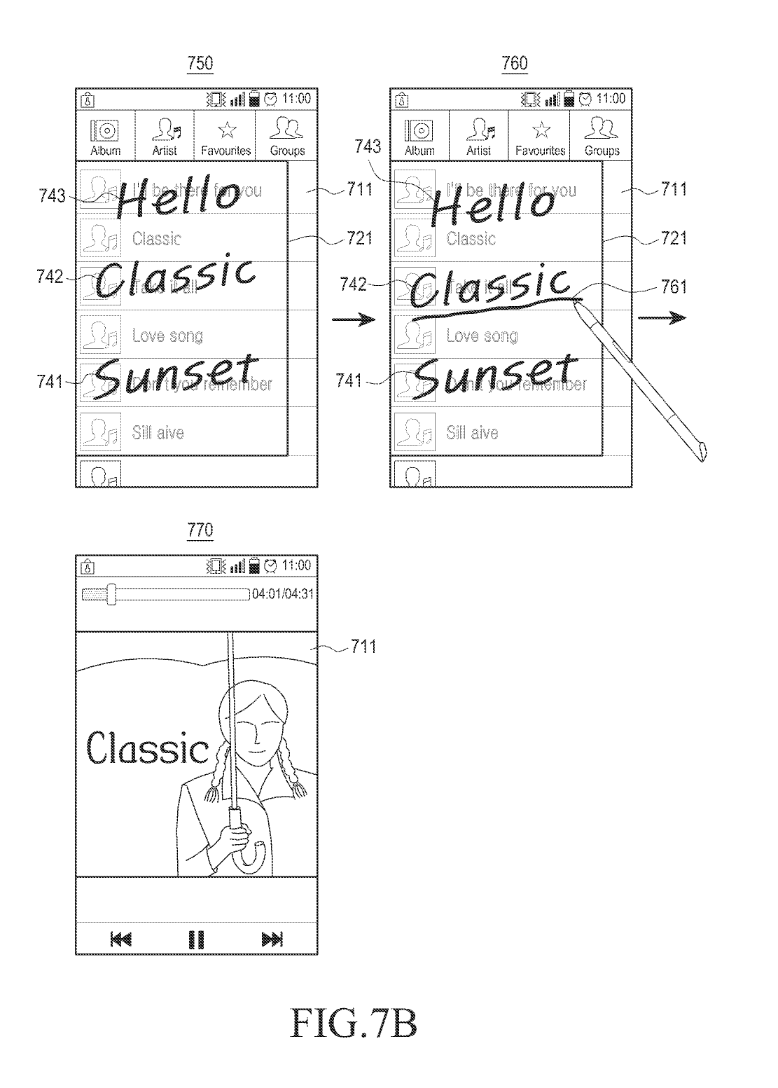

FIGS. 7A and 7B illustrate an example of controlling a function of an application using a handwriting history on a memo window according to an embodiment of the present disclosure.

Referring to FIG. 7A, at the operation indicated by reference numeral 710, the portable device 100 may display a music application 711 as a running application on the touch screen 140. In addition, the portable device 100 may detect a touch drag gesture 712 using the touch pen on the touch screen 140.

At the operation indicated by reference numeral 720, in response to the detected touch drag gesture 712, the portable device 100 may provide a memo window 721 to be superimposed on the music application 711.

At the operation indicated by reference numeral 730, the portable device 100 may detect a touch drag gesture 731 in the vertical direction on the memo window 721 that is superimposed on the music application 711.

At the operation indicated reference numeral 740, in response to the touch drag gesture 731, the portable device 100 may display a plurality of music titles 741 and 742 previously input by the user on the memo window 721 that is superimposed on the music application 711. In addition, the portable device 100 may continuously detect a touch drag gesture 749 by the user in the vertical direction on the memo window 721.

Referring to FIG. 7B, at operation 750, if the touch drag gesture 749 is continued in the vertical direction on the memo window 721 that is superimposed on the music application 711, the portable device 100 may continuously display the plurality of music titles 741, 742 and 743 previously input by the user in the vertical direction corresponding to the above-mentioned direction.

At the operation indicated by reference numeral 760, the portable device 100 may detect a gesture 761 that draws an underline below a specific music title by the touch pen in the state in which the plurality of music titles 741, 742 and 743 are displayed on the memo window 721 that is superimposed on the music application 711.

In addition, at the operation indicated by reference numeral 770, in response to the detected gesture, the portable device 100 may deliver a text corresponding to the selected music title 742 to the music application 711 and reproduce a music corresponding to the selected music title 742 using the music application 711.

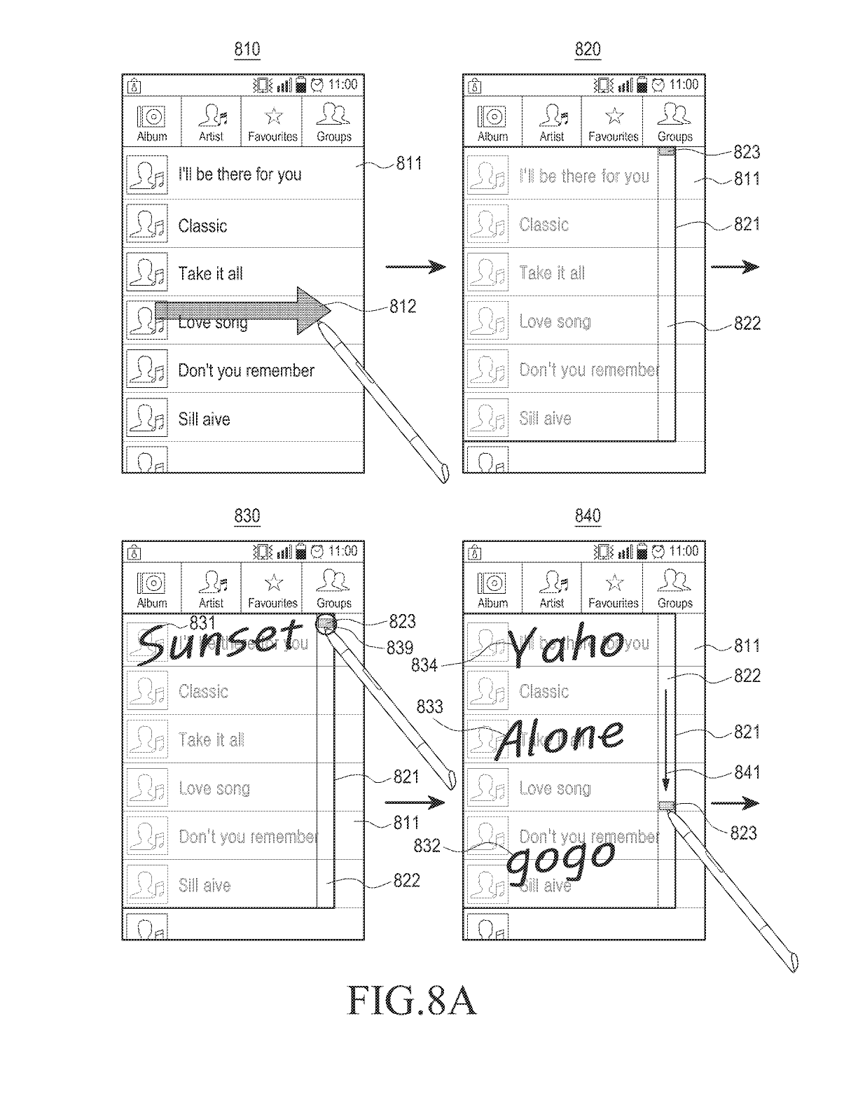

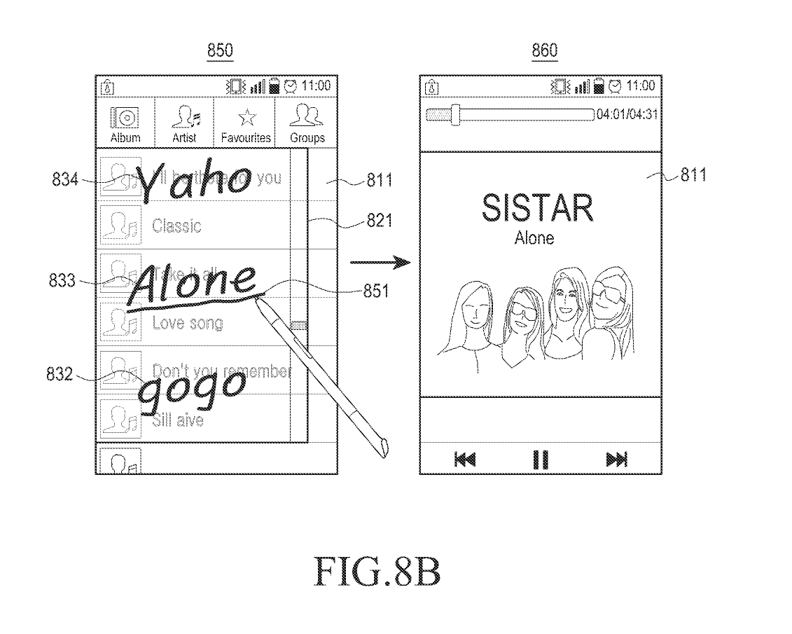

FIGS. 8A and 8B illustrate an example of controlling a function of an application using a handwriting history on a memo window according to an embodiment of the present disclosure.

Referring to FIG. 8A, at the operation indicated by reference numeral 810, the portable device 100 may display a music application 811 as a running application on the touch screen 140. The portable device 100 may detect a touch drag gesture 812 using the touch pen on the touch screen 140.

At the operation indicated by reference numeral 820, in response to the detected touch drag gesture 812, the portable device 100 may provide a memo window 821 to be superimposed on the music application 811. According to various embodiments of the present disclosure, at a side of the memo window 821, a scroll bar 822 may be displayed. The scroll bar 822 may be displayed when the memo window 821 is initially provided or when a predetermined user's gesture is detected after the memo window 821 is provided (e.g., when a side of the memo window is touched for a predetermined length of time). The size of a position indicator 823 included in the scroll bar 822 may be changed depending on the number of handwriting histories previously input by the user. When the number of the handwriting histories is large, the size of the position indicator 823 may become relatively smaller, and when the number of the handwriting histories is small, the size of the position indicator 823 may become relatively larger.

At the operation indicated by reference numeral 830, the portable device 100 may move the position indicator 823 to a position 839 touched by the user on the scroll bar 822. In addition, a music title 831 corresponding to the position of the position indicator 823 may be displayed on the memo window 821 that is superimposed on the music application 811.

At the operation indicated by reference numeral 840, the portable device 100 may move the position of the position indicator 823 on the scroll bar 822 according to the user's touch drag gesture 841. According to various embodiments of the present disclosure, music titles 832, 833 and 834 corresponding to the position of the moved position indicator 823 may be displayed on the memo window 821 that is superimposed on the music application 811.

Referring to FIG. 8B, at the operation indicated by reference numeral 851, the portable device 100 may detect the user's gesture that draws an underline below a specific music title 833 by the touch pen in the state in which the plurality of music titles 832, 833 and 834 are displayed on the memo window 821 that is superimposed on the music application 811.

At the operation indicated by reference numeral 860, in response to the detected gesture, the portable device 100 may deliver a text corresponding to the selected music title 833 to the music application 811 and reproduce a music corresponding to the music title 833 using the music application 811.

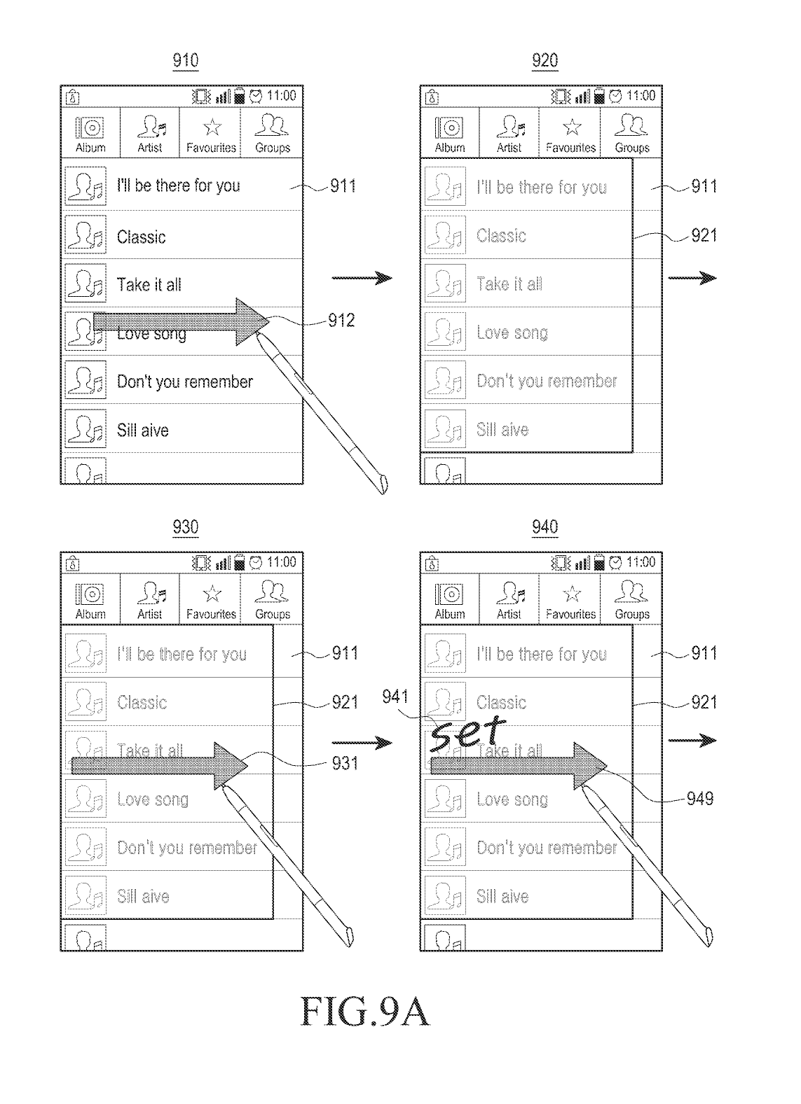

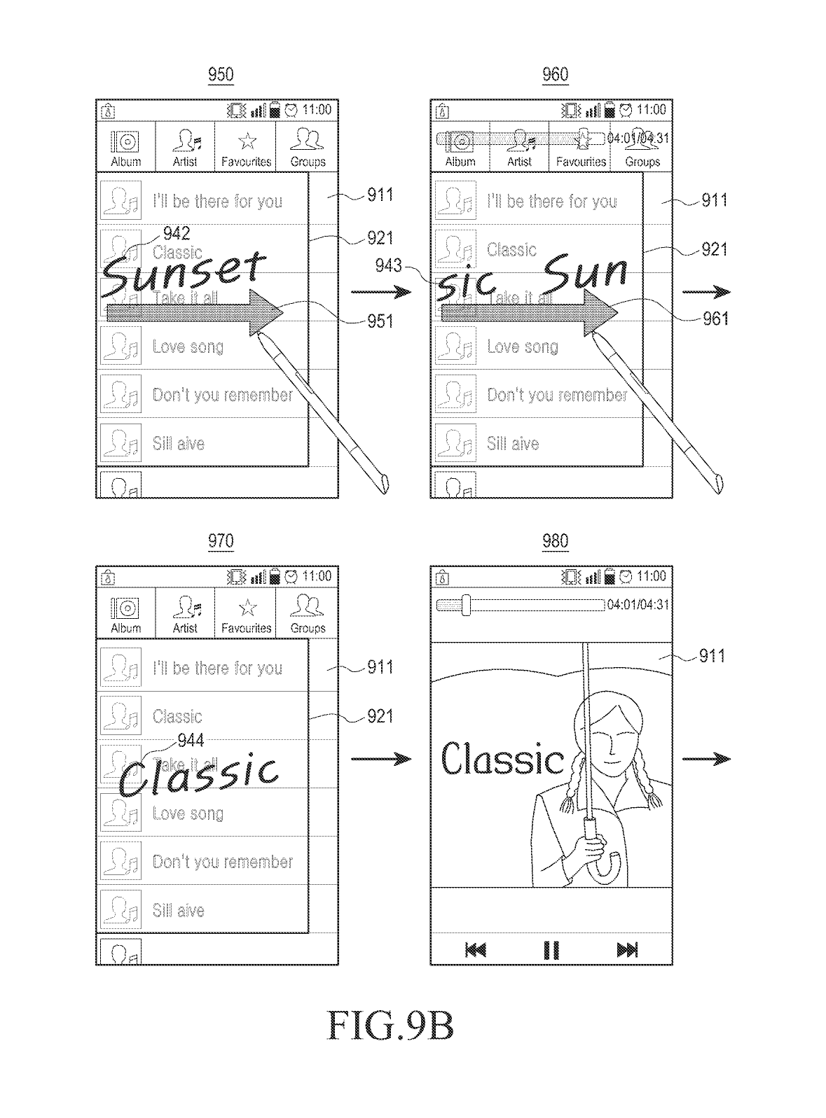

FIGS. 9A and 9B illustrate an example of controlling a function of an application using a handwriting history on a memo window according to an embodiment of the present disclosure.

Referring to FIG. 9A, at the operation indicated by reference numeral 910 in FIG. 9A, the portable device 100 may display a music application 911 on the touch screen 140 as a running application. In addition, the portable device 100 may detect a touch drag gesture 912 using the touch pen on the touch screen 140.

At the operation indicated by reference numeral 920, in response to the detected touch drag gesture 912, the portable device 100 may provide a memo window 921 to be superimposed on the music application 911.

At the operation indicated by reference numeral 930, the portable device 100 may detect a touch drag gesture 931 in the horizontal direction on the memo window 921 that is superimposed on the music application 911.

At the operation indicated by reference numeral 940, in response to the touch drag gesture 931, the portable device 100 may display a part of a music title 941 previously input by the user on the memo window 921 that is superimposed on the music application 911. Then, the portable device 100 may continuously detect the user's touch drag gesture 949 in the horizontal direction on the memo window 921.

Referring to FIG. 9B, at the operation indicated by reference numeral 950, if the touch drag gesture 949 is continued in the horizontal direction, then the portable device 100 may display a music title 942 previously input by the user on the memo window 921 that is superimposed on the music application 911. Then, the portable device 100 may continuously detect the user's touch drag gesture 951 in the horizontal direction on the memo window 921.

At the operation indicated by the reference numeral 960, if the touch drag gesture 951 is continuously continued in the horizontal direction, the portable device 100 may continuously display a part of another music title 943 previously input by the user on the memo window 921 that is superimposed on the music application 911. In addition, the portable device 100 may continuously detect the user's touch drag gesture 961 in the horizontal direction on the memo window 921.

At the operation indicated by reference numeral 970, in response to the detected touch drag gesture 961, the portable device 100 may display another music title 944 on the memo window 921 that is superimposed on the music application 911. Then, the portable device 100 may detect whether a user's gesture is input for a predetermined length of time (e.g., one sec).

If no user's gesture is detected for the predetermined length of time, then the portable device 100 may proceed to an operation indicated by reference numeral 980 at which the portable device 100 may deliver a text corresponding to the music title 944 displayed on the memo window 921 to the music application 911 and reproduce the music corresponding to the music title 944 using the music application 911.

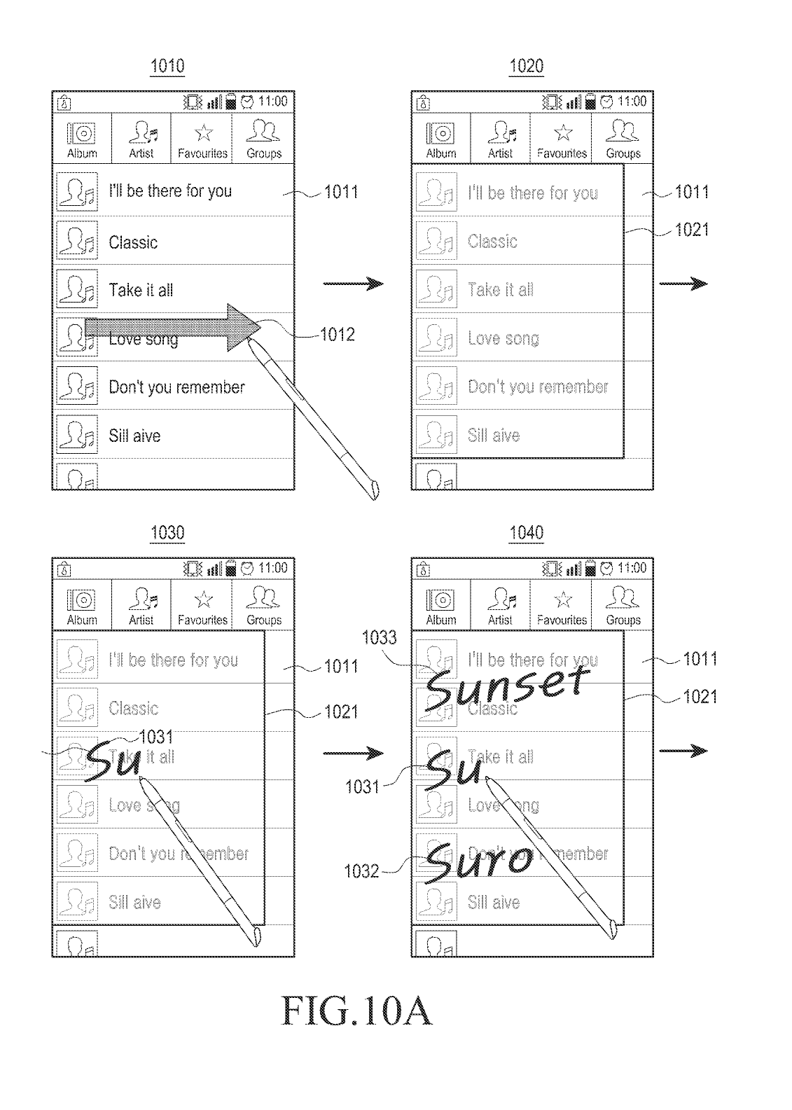

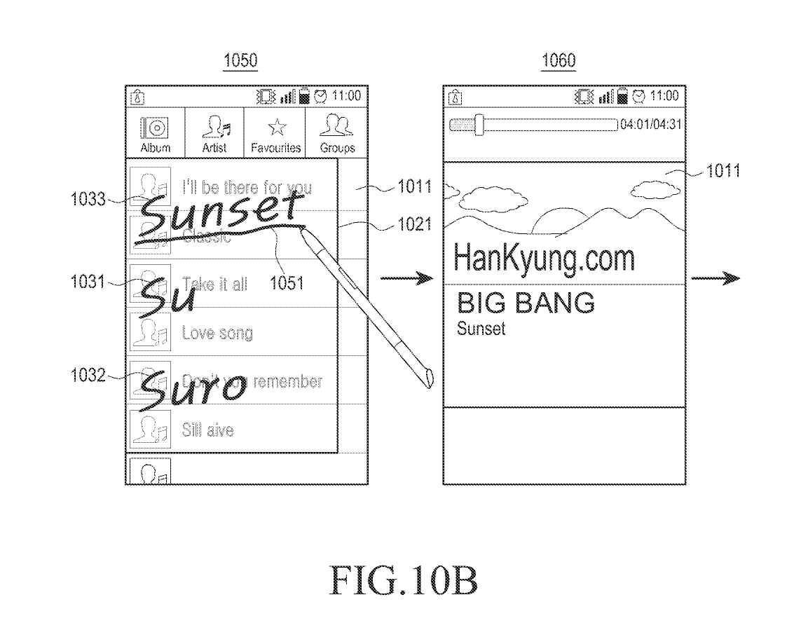

FIGS. 10A and 10B illustrate an example of controlling a function of an application using a handwriting history on a memo window according to an embodiment of the present disclosure.

Referring to FIG. 10A, at the operation indicated by reference numeral 1010, the portable device 100 may display the music application 1011 on the touch screen 140 as a running application. Then, the portable device 100 may detect a touch drag gesture 1012 using the touch pen on the touch screen 1011.

At the operation indicated by reference numeral 1020, in response to the detected touch drag gesture 1012, the portable device 100 may provide a memo window 1021 to be superimposed on the music application 1011.

At the operation indicated by reference numeral 1030, the portable device 100 may receive an input, from the touch pen, of a handwriting image related to a part of a music title 1031 on the memo window 1021 that is superimposed on the music application 1011.

At the operation indicated by reference numeral 1040, if only a part of the music title 1031 is handwritten, then the portable device 100 may display other music titles 1032 and 1033 starting with the part of the music title 1031 on the memo window 1021 that is superimposed with the music application 1011. According to various embodiments of the present disclosure, the other music titles 1032 and 1033 may be selected from a plurality of handwriting histories previously input by the user, or may be searched for from the portable device 100 or a server (not illustrated) outside the portable device 100 to be displayed on the memo window 1021.

Referring to FIG. 10B, at the operation indicated by reference numeral 1050, the portable device 100 may detect a gesture 1051 that draws an underline below a specific music title 1033 by the touch pen in the state in which the plurality of music titles 1032 and 1033 are displayed on the memo window 1021 that is superimposed on the music application 1011.

In addition, at the operation indicated by reference numeral 1060, in response to the detected gesture 1051, the portable device 100 delivers a text corresponding to the selected music title 1033 to the music application 1011 and reproduces a music corresponding to the music title 1033 using the music application 1011.

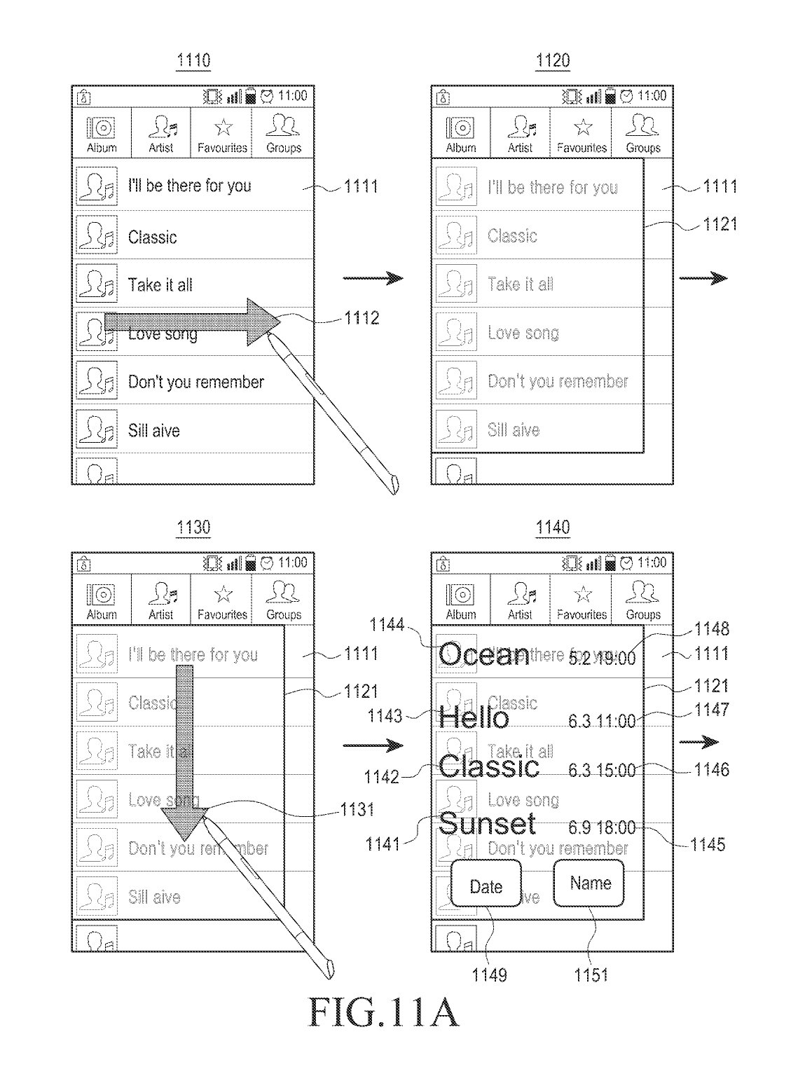

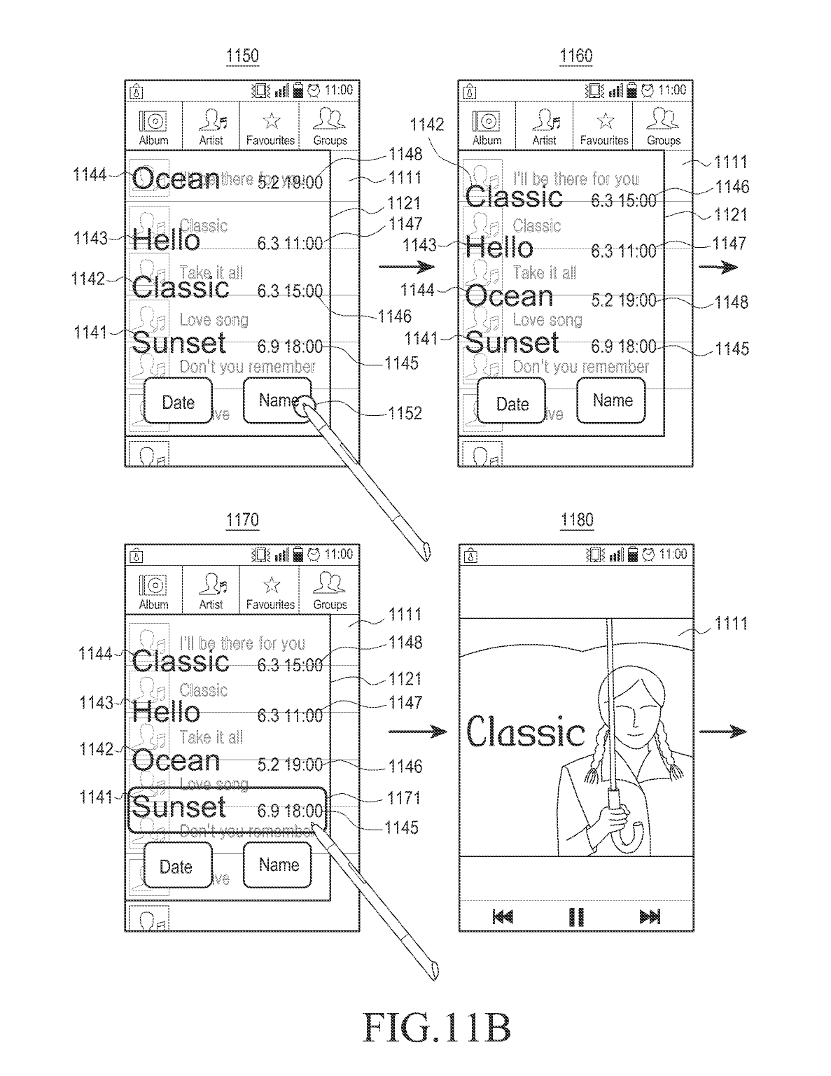

FIGS. 11A and 11B illustrate an example of controlling a function of an application using a handwriting history on a memo window according to an embodiment of the present disclosure.

Referring to FIG. 11A, at the operation indicated by reference numeral 1110, the portable device 100 may display a music application 1111 on the touch screen 140 as a running application. Then, the portable device 100 may detect a touch drag gesture 1112 using the touch pen on the touch screen 140.

At the operation indicated by reference numeral 1120, in response to the detected touch drag gesture 1112, the portable device 100 may provide a memo window 1121 to be superimposed on the music application 1111.

At the operation indicated by reference numeral 1130, the portable device 100 may detect a touch drag gesture 1131 in the vertical direction on the memo window 1121 that is superimposed on the music application 1111.

At the operation indicated by reference numeral 1140, in response to the touch drag gesture 1131 the portable device 100 may display a plurality of music titles 1141, 1142, 1143, and 1144 previously input by the user on the memo window 1121 that is superimposed on the music application 1111. According to various embodiments of the present disclosure, each of the plurality of music titles 1141, 1142, 1143, and 1144 may be displayed in the form of a text which is a recognition result of a previously input handwriting image. In addition, on the memo window 1121, the times 1145, 1146, 1147, and 1148 when the plurality of previously input music titles 1141, 1142, 1143, and 1144 were input may be displayed as well. The memo window 1121 may further include buttons 1149 and 1151 so as to align the plurality of music titles 1141, 1142, 1143, and 1144.

If a date aligning button 1149 is selected, the portable device 100 may align the music titles 1141, 1142, 1143, and 1144 with reference to the dates to be displayed on the memo window 1121.

If a name aligning button 1151 is selected, the portable device 100 may align the plurality of music titles 1141, 1142, 1143, and 1144 with reference to the names to be displayed on the memo window 1121.

At the operation indicated by reference numeral 1150, the portable device 100 may detect the user's touch 1152 that selects the name aligning button 1151 on the memo window 1121 that is superimposed on the music application 1111.

At the operation indicated by reference numeral 1160, in response to the user's touch 1152, the portable device 100 may align the plurality of music titles 1141, 1142, 114, and 1144, with reference to alphabetical order from A to Z, on the memo window 1121 that is superimposed on the music application 1111.

At the operation indicated by reference numeral 1170, the portable device 100 may detect a gesture 1171 that touches at least one music title 1141 by the touch pen in the state where the plurality of music titles 1141, 1142, 1143, and 1144 are displayed on the memo window 1121 that is superimposed on the music application 1111.

At the operation indicated by reference numeral 1180, in response to the detected gesture 1171, the portable device 100 may deliver a text corresponding to the selected music title 1141 to the music application 1111 and reproduce a music corresponding to the music title 1141 using the music application 1111.

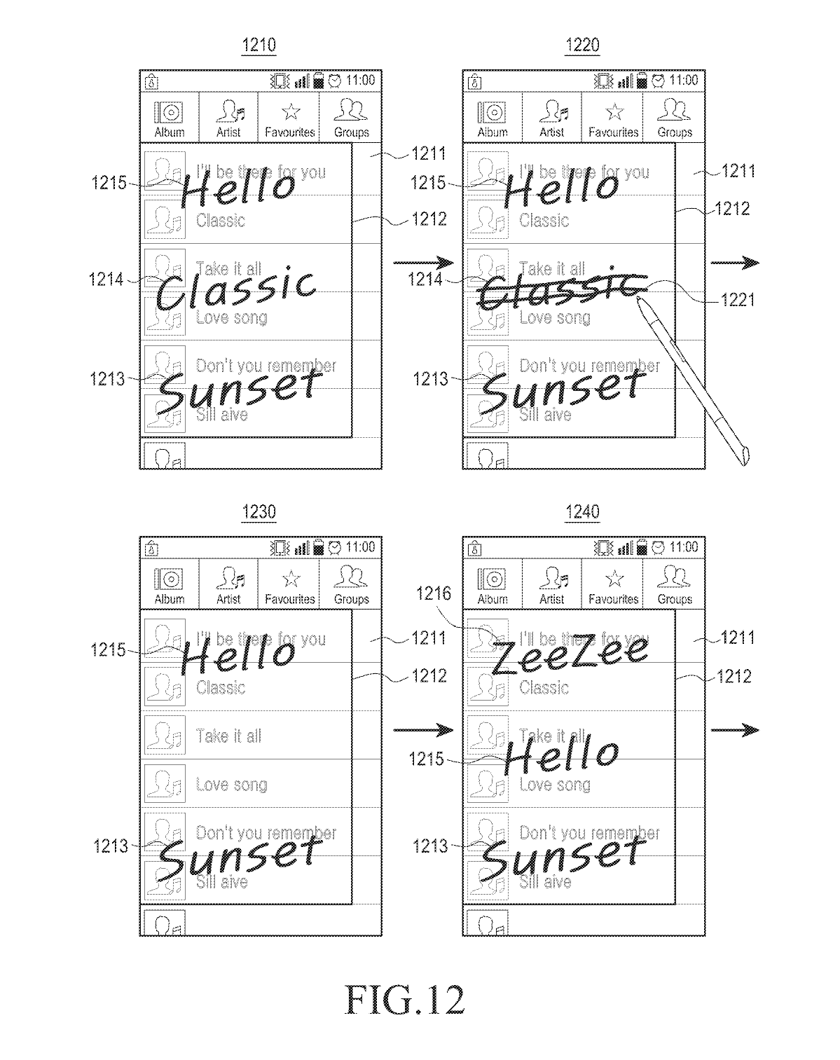

FIG. 12 illustrates an example of deleting at least one of handwriting histories displayed on a memo window according to an embodiment of the present disclosure.

Referring to FIG. 12, at the operation the indicated by reference numeral 1210, the portable device 100 may provide a memo window 1212 on which a plurality of handwriting histories 1213, 1214 and 1215 are displayed to be superimposed on a running music application 1211.

At the operation indicated by reference 1220, the portable device 100 may detect the user's gesture 1221 that deletes at least one handwriting history 1214 among the plurality of handwriting histories 1213, 1214 and 1215 that are superimposed on the music application 1211. For example, the user's gesture 1221 may be a gesture that draws a cancel line on a handwriting history desired to be deleted.

At the operation indicated by reference numeral 1230, in response to the user's gesture 1221, the portable device 100 may delete a handwriting history 1214 selected on the memo window 1212 that is superimposed on the music application 1211.

At the operation indicated by reference numeral 1240, a handwriting history 1215 input prior to the deleted handwriting history may be moved to the position at which the deleted handwriting history 1214 has been displayed. Then, a handwriting history 1216 input prior to the moved handwriting history 1215 may be moved to the position at which the handwriting history 1215 has been displayed in sequence.

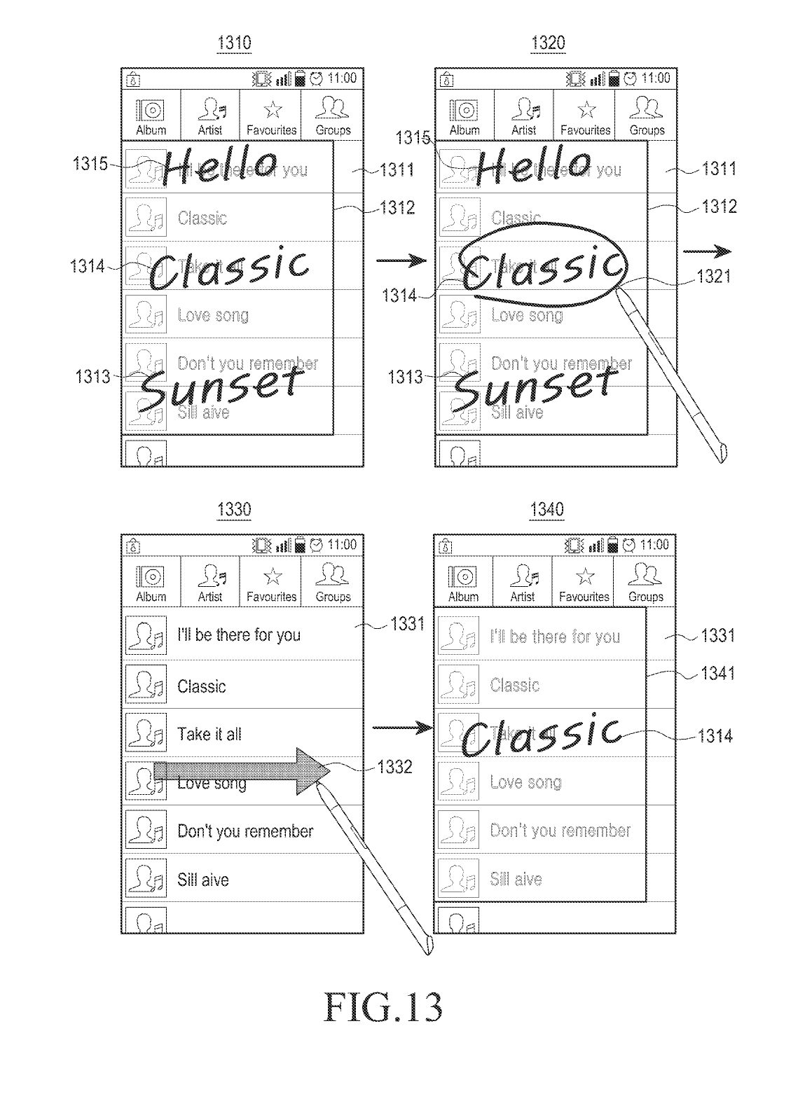

FIG. 13 illustrates an example of bookmarking at least one of handwriting histories displayed on a memo window according to an embodiment of the present disclosure.

Referring to FIG. 13, at the operation indicated by reference numeral 1310, the portable device 100 may provide a memo window 1312 on which a plurality of handwriting histories 1313, 1314 and 1315 are displayed to be superimposed on a running music application 1311.

At the operation indicated by reference numeral 1320, the portable device 100 may detect the user's gesture 1321 that bookmarks at least one handwriting history 1314 among the plurality of handwriting histories 1313, 1314 and 1315 displayed on the memo window 1312 that is superimposed on the music application 1311. For example, the user's gesture 1321 may be a gesture 1321 that draws a closed loop around a handwriting history 1314 desired to be bookmark.

Then, after the music application 1311 is finished, a music application 1331 may be executed again by the user. According to various embodiments of the present disclosure, the music application 1311 may be an application which is executed at a different time from the time of the music application 1331 and is the same as or different from the music application 1331.

At the operation indicated by reference numeral 1330, the portable device 100 may receive an input of the user's touch drag gesture 1332 on a running music application 1331.

At the operation indicated by reference numeral 1340, in response to the user's touch drag gesture 1332, the portable device 100 may provide a memo window 1341 in a state in which the bookmarked handwriting history 1314 is displayed on the memo window when providing the memo window 1341 to be superimposed on the running music application 1331.

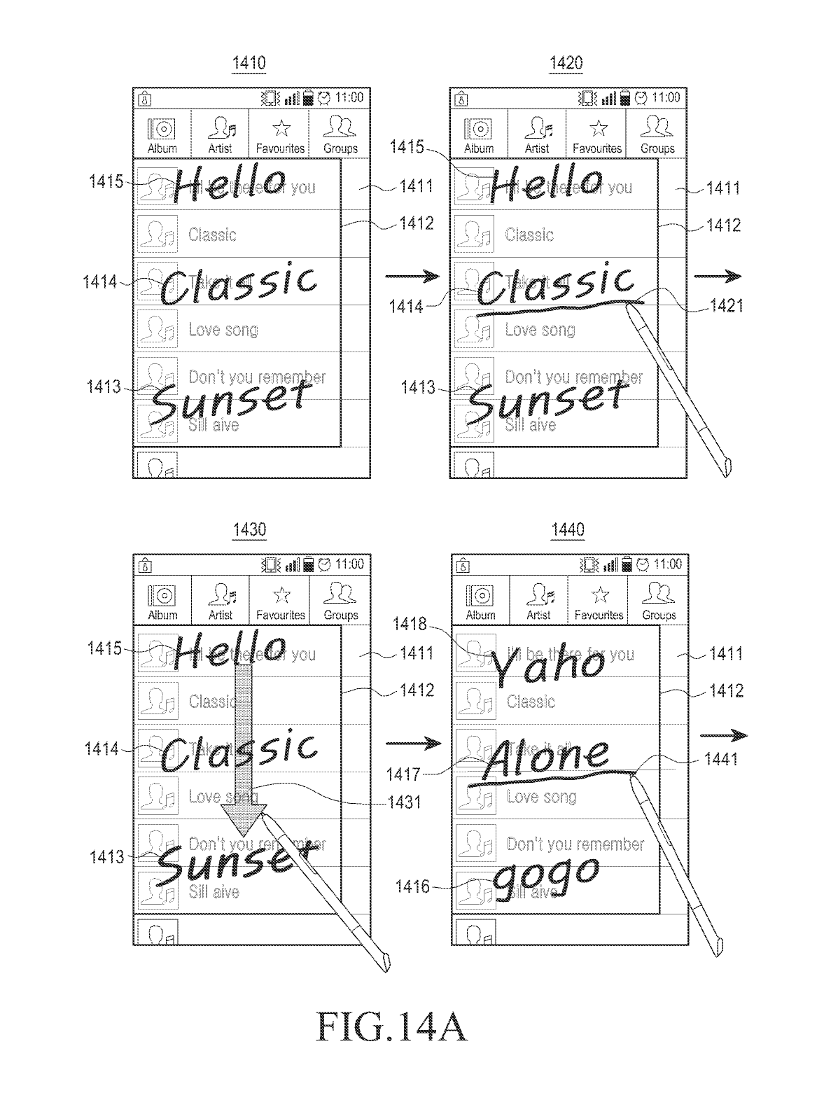

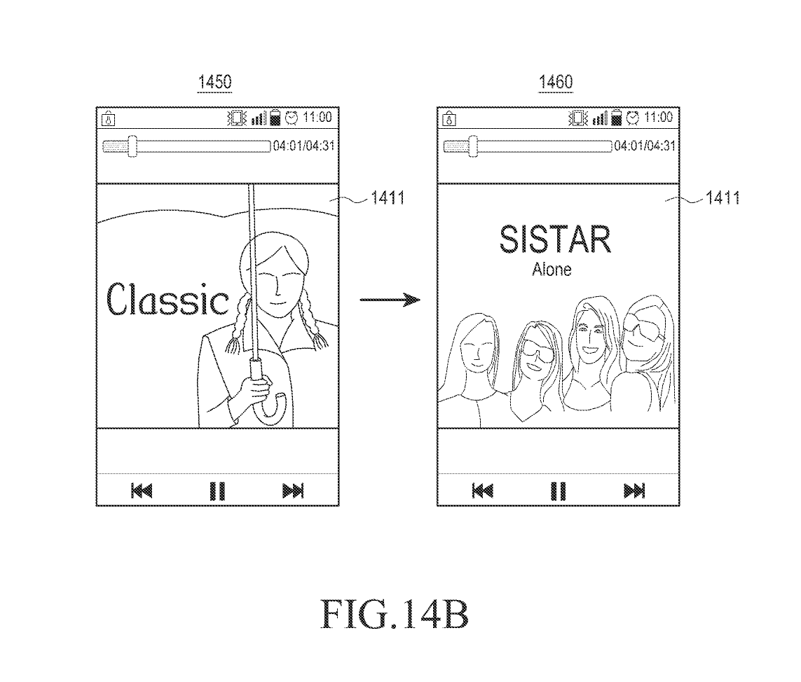

FIGS. 14A and 14B illustrate an example of controlling an application using a plurality of handwriting histories on a memo window according to an embodiment of the present disclosure.

Referring to FIG. 14A, at the operation indicated by reference numeral 1410, the portable device 100 may provide a memo window 1412 on which a plurality of handwriting histories 1413, 1414 and 1415 are displayed to be superimposed on a running music application 1411.

At the operation indicated by reference numeral 1420, the portable device 100 may detect a gesture 1421 that selects at least one handwriting history 1414 among the plurality of handwriting histories 1413, 1414 and 1415 on the memo window 1412 that is superimposed on the music application 1411.

At the operation indicated by reference numeral 1430, the portable device 100 may detect the user's gesture 1431 in the vertical direction in the state in which the handwriting histories 1413, 1414 and 1415 are displayed on the memo window 1412 that is superimposed on the music application 1411.

At the operation indicated by reference numeral 1440, in response to the gesture 1431 in the vertical direction, the portable device 100 may display a plurality of handwriting histories 1416, 1417 and 1418 which are different from the plurality of handwriting histories 1413, 1414 and 1415 in the vertical direction. Then the portable device 100 may detect the user's gesture 1441 that selects at least one handwriting history 1417 among the plurality of other handwriting histories 1416, 1417 and 1418 displayed on the memo window 1412 superimposed on the music application 1411.

At the operation indicated by reference numeral 1450, the portable device 100 may reproduce a music corresponding to a handwriting history 1421 selected by the user in the operation indicated by reference numeral 1420 using the music application 1411.

At the operation indicated by reference numeral 1460, after the music corresponding to the selected handwriting history 1421 is finished, the portable device 100 may reproduce in sequence a music corresponding to another handwriting history 1417 selected by the user in the operation indicated by reference numeral 1440 using the music application 1411 without a separate user's input.

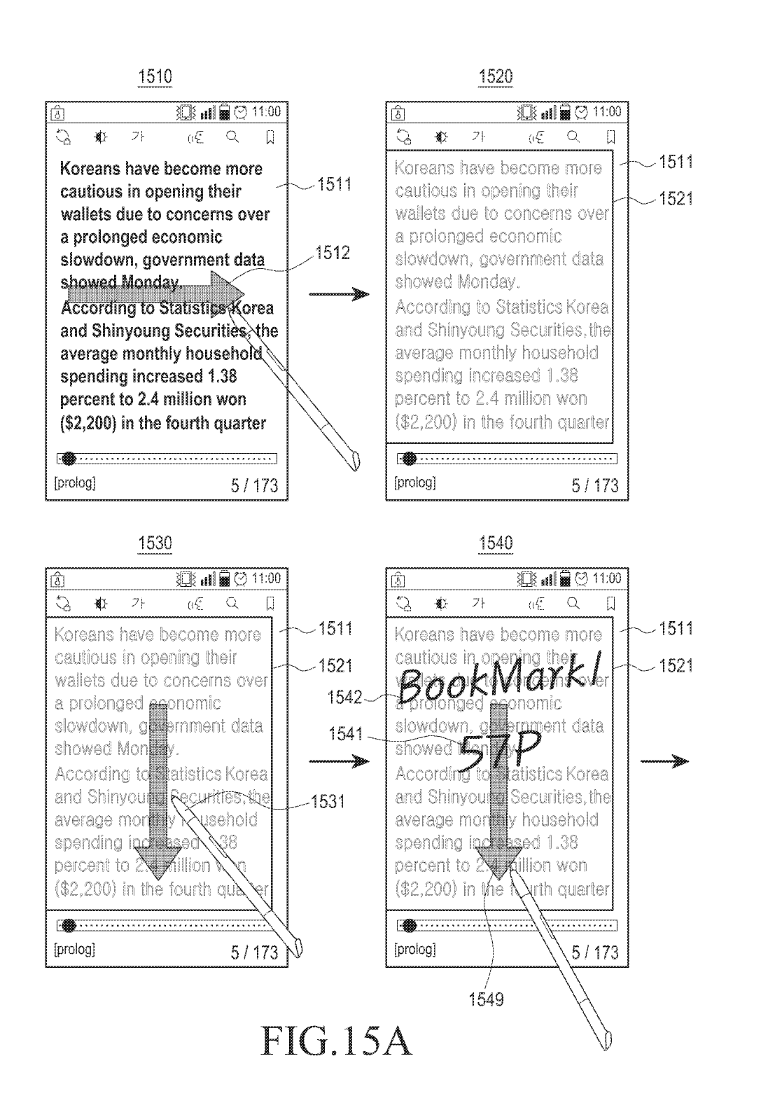

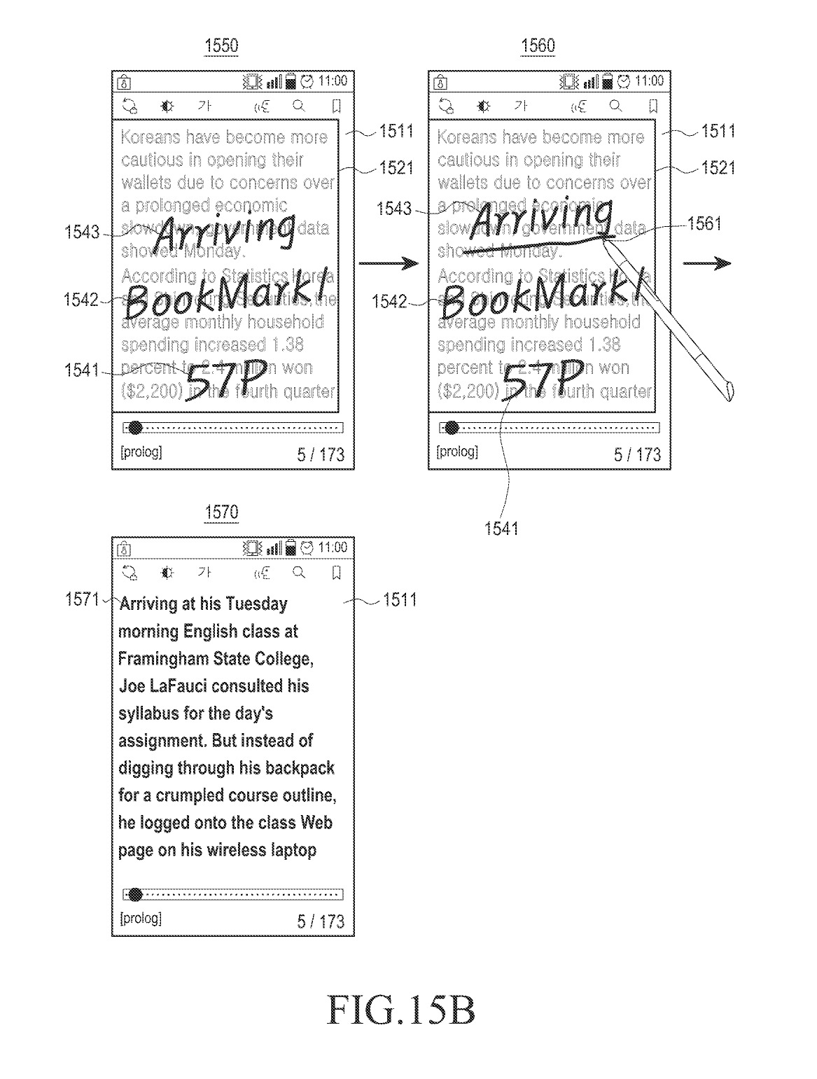

FIGS. 15A and 15B illustrate an example of controlling a function of an e-book application using a handwriting history on a memo window according to an embodiment of the present disclosure.

Referring to FIG. 15A, at the operation indicated by reference numeral 1510, the portable device 100 may display an e-book application 1511 on the touch screen 140 as a running application. Then, the portable device 100 may detect a touch drag gesture 1512 using the touch pen on the touch screen 140.

At the operation indicated by reference numeral 1520 of FIG. 15A, in response to the detected touch drag gesture 1512, the portable device 100 may provide a memo window 1521 to be superimposed on the e-book application 1511.

At the operation indicated by reference numeral 1530 of FIG. 15A, the portable device 100 may detect a touch drag gesture 1531 in the vertical direction on the memo window 1521 that is superimposed on the e-book application 1511.

At the operation indicated by reference numeral 1540 of FIG. 15A, in response to the touch drag gesture 1531, the portable device 100 may display at least one of a page number 1541 previously input by the user for page search and a bookmark number 1542. Then, the portable device 100 may continuously detect the user's touch drag gesture 1549 in the vertical direction on the memo window 1521 that is superimposed on the e-book application 1511.

Referring to FIG. 15B, at the operation indicated by reference numeral 1550, if the touch drag gesture 1549 is continuously continued in the vertical direction, then the portable device 100 may continuously display the page number 1541 previously input by the user for the page search, the bookmark number 1542, and a search word 1543 in the vertical direction corresponding to the above-mentioned direction.

At the operation indicated by reference numeral 1560, the portable device 100 may detect a gesture 1561 that draws an underline below one of the page number 1541, the bookmark number 1542, and the search word 1543.

At the operation indicated by reference numeral 1570, in response to the detected gesture, the portable device 100 may deliver a text corresponding to the selected search word 1543 to the e-book application 1511, and display a page in which the search word 1571 is included using the e-book application 1511.

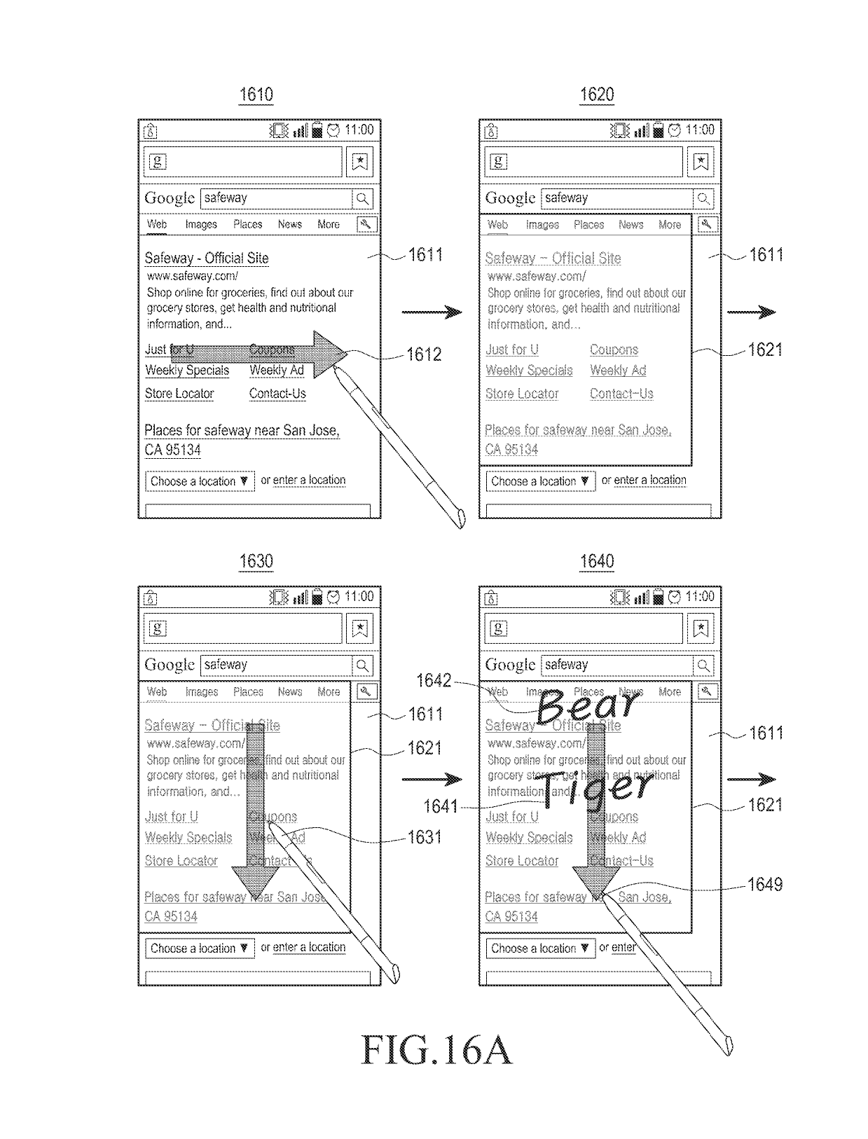

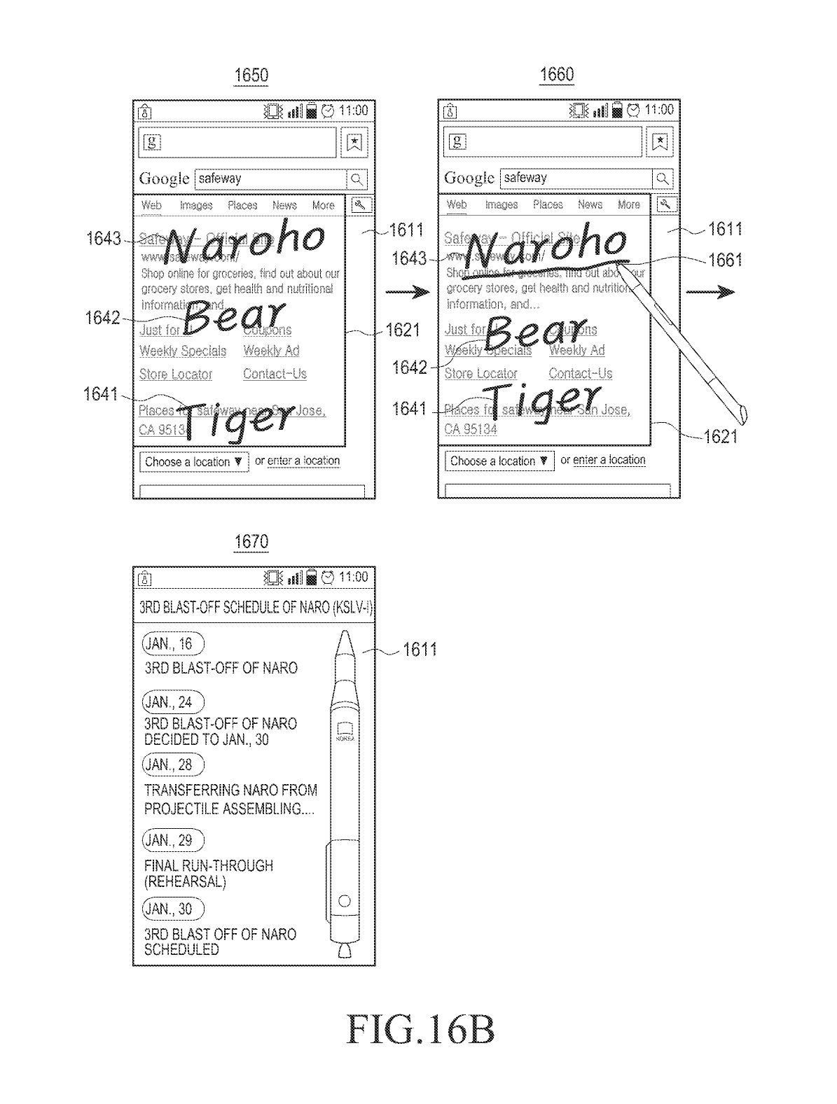

FIGS. 16A and 16B illustrate an example of controlling a function of a search application using a handwriting history on a memo window according to an embodiment of the present disclosure.

Referring to FIG. 16A, at the operation indicated by reference numeral 1610, the portable device 100 may display a search application 1611 on the touch screen 140 as a running application. Then, the portable device 100 may detect a touch drag gesture 1612 using the touch pen on the touch screen 140.

At the operation indicated by reference numeral 1620, in response to the detected touch drag gesture 1612, the portable device 100 may provide a memo window 1621 to be superimposed on the search application 1611.

At the operation indicated by reference numeral 1630, the portable device 100 may detect a touch drag gesture 1631 in the vertical direction on the memo window 1621 that is superimposed on the search application 1611.

At the operation indicated by reference numeral 1640, in response to the touch drag gesture 1631, the portable device 100 may display search words 1641 and 1642 previously searched for by the user on the memo window 1621. Then, the portable device 100 may continuously detect the user's touch drag gesture 1649 in the vertical direction on the memo window 1621 that is superimposed on the search application 1611.

Referring to FIG. 16B, at the operation indicated by the reference numeral 1650, if the touch drag gesture 1649 is continued in the vertical direction, then, in response to the touch drag gesture 1649, the portable device 100 may display search words 1641, 1642 and 1643, previously searched for by the user, on the memo window 1621 that is superimposed on the search application 1611.

At the operation indicated by reference numeral 1660, the portable device 100 may detect a gesture 1661 that draws an underline by the touch pen below a specific search word 1643 among the search words 1641, 1642 and 1643 displayed on the memo window 1621 that is superimposed on the search application 1611.

At the operation indicated by reference numeral 1670, the portable device 100 may deliver a text corresponding to the selected search word 1643 to the search application 1611, and may search for and display a page in which detailed information related to the search word 1643 is included using the search application 1611.

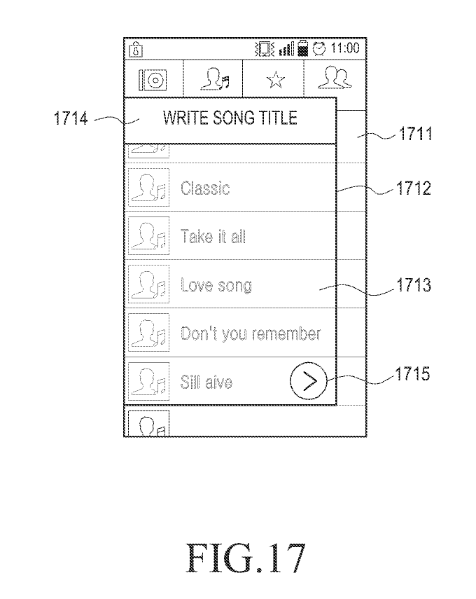

FIG. 17 illustrates an example of a memo window according to an embodiment of the present disclosure.

Referring to FIG. 17, a memo window 1712 displayed to be superimposed on a running application 1711 may include a handwriting input feasible region 1713 and a handwriting input infeasible region 1714 or 1715. The handwriting input feasible region 1713 may correspond to a region at which, when a handwriting image is input by the touch pen, the handwriting image is recognized and converted into a text. In contrast, the handwriting input infeasible region 1714 and/or 1715 may be a region at which a user's touch may be detected but an input handwriting image is not converted into a text. For example, the handwriting input infeasible region 1714 and/or 1715 may be a region 1714 that informs the user of what is to be handwritten on the memo window 1712, or a region 1715 that, when a handwriting input is made on the memo window 1712, requests conversion of the input handwriting image into a text.

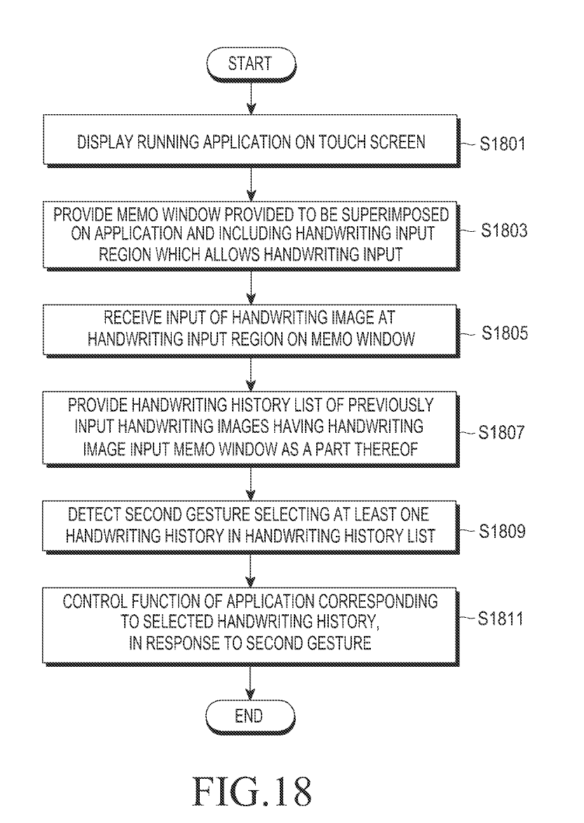

FIG. 18 illustrates a flowchart for describing an application control method of a portable device according to an embodiment of the present disclosure.

Referring FIG. 18, at operation S1801, the portable device 100 may display a running application on the touch screen 140.

At operation S1803, the portable device 100 may provide a memo window that includes a handwriting input region which allows a handwriting input to be superimposed on the running application.

At operation S1805, the portable device 100 may receive an input of a user's handwriting image at the handwriting input region on the memo window through the input panel 142 of the touch screen 140.

At operation S1807, the portable device 100 may provide a previously input handwriting history list having the handwriting image input on the memo window as a part, from the storage unit 150. For example, if the handwriting image input on the memo window is “su”, then the portable device 100 may search for, in the storage unit 140, handwriting images beginning with “su”, for example, “sunset” and “suro” and provide the searched-for handwriting images on the memo window.

At operation S1809, the portable device 100 may detect the user's second gesture that selects at least one handwriting history from the handwriting history list. For example, the portable device may detect a user's second gesture corresponding to a user's gesture that draws an underline below a handwriting history desired to select either “sunset” or “suro”.

At operation S1811, in response to the detected user's gesture, the portable device 100 may control the function of an application corresponding to the selected handwriting history.

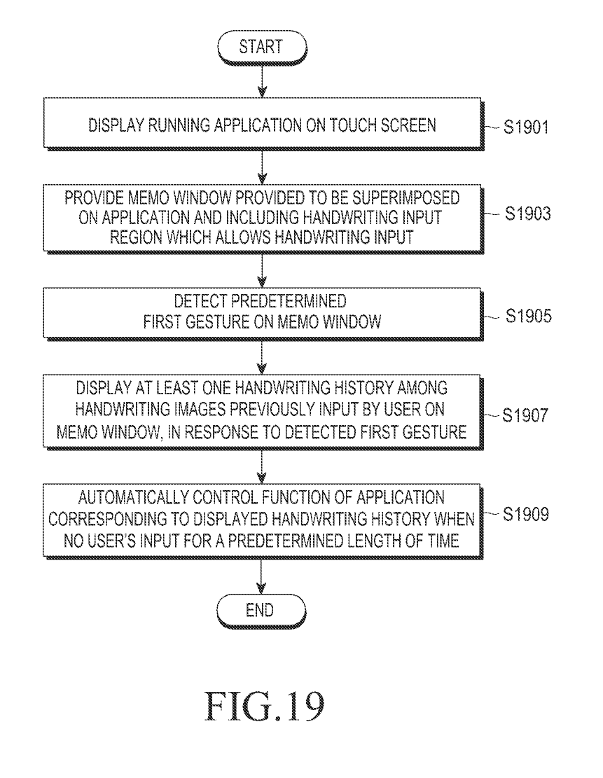

FIG. 19 is a flowchart for describing an application control method of the portable device according to an embodiment of the present disclosure.

Referring to FIG. 19, at operation S1901, the portable device 100 may display a running application on the touch screen.

At operation S1903, the portable device 100 may provide a memo window including a handwriting input region which is provided to be superimposed on the application and allows a handwriting input.

At operation S1905, the portable device 100 may detect a predetermined first gesture on the memo window. According to various embodiments of the present disclosure, the user's predetermined gesture may be a gesture of touch dragging (e.g., from a side of the touch screen 140 toward the center thereof).

At operation S1907, in response to the detected first gesture, the portable device 100 may display a handwriting history among at least one of the handwriting images previously input by the user on the memo window.

At operation S1909, if no user's input exists for a predetermined length of time (e.g., 0.5 sec), then the portable device 100 may automatically control the function of the application corresponding to at least one handwriting history displayed on the memo window.

According to various embodiments of the present disclosure, when a plurality of handwriting histories are displayed on the memo window, the portable device 100 may sequentially control the functions of the applications corresponding to the plurality of handwriting histories. For example, when an application is a music application and two or more music titles are displayed on the memo window, the portable device 100 may sequentially reproduce music corresponding to the two music titles, respectively, after a predetermined length of time.

It may be appreciated that the various embodiments of the present disclosure can be implemented in software, hardware, or a combination thereof. Any such software may be stored, for example, in a volatile or non-volatile storage device such as a Read Only Memory (ROM), a memory such as a Random Access Memory (RAM), a memory chip, a memory device, or a memory IC, or a recordable optical or magnetic medium such as a Compact Disc (CD), a Digital Versatile Disc (DVD), a magnetic disk, or a magnetic tape, regardless of its ability to be erased or its ability to be re-recorded. It can be also appreciated that the software may be stored in a machine (e.g., a computer)-readable storage medium.

It may be appreciated that a portable device using a touch and an application control method using the same according to various embodiments of the present disclosure may be implemented by a computer or a portable device that includes a control unit and a memory, and the memory is an example of a non-transitory machine-readable storage medium (e.g., a non-transitory computer-readable storage medium) which is suitable for storing a program or programs including instructions that implement the various embodiments of the present disclosure.

Accordingly, various embodiments of the present disclosure include a program for a code implementing the apparatus and method described in the appended claims of the specification and a non-transitory machine-readable storage medium (e.g., a non-transitory computer-readable storage medium) for storing the program. Moreover, such a program as described above can be electronically transferred through an arbitrary medium such as a communication signal transferred through cable or wireless connection, and the present disclosure properly includes the things equivalent to that.

In addition, the portable device using a touch pen may receive and store a program from a program providing device which is wiredly or wirelessly connected thereto. Furthermore, a user may adjust the setting of the user's portable device so that the operations according to the various embodiments of the present disclosure may be limited to a user terminal or extended to be interlocked with a server through a network according to the user's choice.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An application control method of a portable device having a touch screen, the application control method comprising:
displaying an application on the touch screen;
providing a memo window including a handwriting input region to be superimposed on the application;
detecting a first gesture on the memo window;
providing, in response to the detected first gesture, a handwriting history list through the memo window;
detecting a second gesture that selects at least one handwriting history in the handwriting history list; and
controlling, in response to the detected second gesture, a function of the application corresponding to the selected handwriting history.

2. The method of claim 1, wherein the providing of the handwriting history list comprises:
providing at least one handwriting image previously input on the memo window or at least one text which is a result of recognizing the at least one handwriting image.

3. The method of claim 1, wherein the providing of the handwriting history list comprises:
displaying, in response to the first gesture continuously moving in a predetermined direction, the handwriting history list continuously through the memo window in a direction corresponding to the predetermined direction.

4. The method of claim 1, further comprising:
detecting a user's third gesture that selects at least one handwriting history in the handwriting history list; and
deleting, in response to the detected user's third gesture, the at least one handwriting history selected in the handwriting history list.

5. The method of claim 1, further comprising:
detecting a user's fourth gesture that selects at least one handwriting history in the handwriting history list; and
changing, in response to the detected user's fourth gesture, a position of the at least one handwriting history selected in the handwriting history list.

6. The method of claim 1, wherein the detecting of the second gesture that selects at least one handwriting history in the handwriting history list comprises:
detecting the second gesture that selects a plurality of handwriting histories in the handwriting history list, and
wherein the controlling of the function of application corresponding to the selected handwriting history comprises:
controlling, in response to the second gesture, a function of an application corresponding to one handwriting history among the plurality of handwriting histories, and controlling a function of an application corresponding to another handwriting history among the plurality of handwriting histories.

7. The method of claim 1, wherein the providing of the handwriting history list comprises:
adjusting at least one of a sequence and an interval of the handwriting histories to be displayed on the memo window; and
displaying the handwriting histories, of which at least one of the sequence and the interval is adjusted, on the memo window.

8. The method of claim 2, wherein the providing of the handwriting history list comprises:
providing detailed content of the handwriting images, which correspond to the handwriting images, respectively, through the memo window.

9. The method of claim 1, wherein the memo window includes a handwriting input infeasible region, and
wherein the handwriting input infeasible region displays at least one of a character and an image provided from the application is displayed on the the handwriting input infeasible region.

10. The method of claim 1, wherein the displaying of the memo window to be superimposed on the application comprises:
displaying the memo window to be superimposed on the application in response to a gesture moving in a direction from an edge of the touch screen to a center of the touch screen.

11. An application control method of a portable device having touch screen, the application control method comprising:
displaying an application on the touch screen;
providing a memo window which is provided on the touch screen to be superimposed on the application and which includes a handwriting input region;
receiving an input of a handwriting image at the handwriting input region on the memo window;
providing a handwriting history list which has been previously input and has the input handwriting image as a part thereof, through the memo window;
detecting a second gesture that selects at least one handwriting history in the handwriting history list; and
controlling, in response to the detected second gesture, a function of the application corresponding to the selected handwriting history.

12. An application control method of a portable device having a touch screen, the application control method comprising:
displaying an application on the touch screen;
providing a memo window which is provided to be superimposed on the application and includes a handwriting input region;
detecting a predetermined first gesture on the memo window;
displaying, in response to the detected first gesture, a handwriting history list through the memo window; and
automatically controlling a function of the application corresponding to the displayed handwriting history if an additional user input is not detected on the touch screen for a predetermined length of time.

13. A portable device comprising:
a storage unit configured to store a handwriting history list input to a memo window provided to be superimposed on an application;
a touch screen configured to, in response to a predetermined first gesture on the memo window provided to be superimposed on the application when the application is executed again, display the handwriting history list stored in the storage unit, and to detect a second gesture that selects at least one handwriting history in the handwriting history list; and
a control unit configured to, in response to the detected second gesture, control a function of the application corresponding to the selected handwriting history.

14. The portable device of claim 13, wherein the touch screen is further configured to display the handwriting history list by displaying at least one handwriting image previously input on the memo window or at least one text which is a result of recognizing the at least one handwriting image.

15. The portable device of claim 13, wherein the touch screen is further configured to, in response to the first gesture continuously moving in a predetermined direction, display the handwriting history list continuously in a direction corresponding to the predetermined direction through the memo window when displaying the handwriting history list.

16. The portable device of claim 13, wherein the touch screen is further configured to detect a user's third gesture that selects at least one handwriting history in the handwriting history list, and
wherein the control unit is further configured to delete, in response to the detected user's third gesture, the at least one handwriting history selected in the handwriting history list.

17. The portable device of claim 13, wherein the touch screen is further configured to detect a user's fourth gesture that selects at least one handwriting history in the handwriting history list, and
wherein the control unit is further configured to change, in response to the detected user's fourth gesture, a position of the handwriting history selected in the handwriting history list.

18. The portable device of claim 13, wherein the touch screen is further configured to detect a second gesture that selects a plurality of handwriting histories in the handwriting history list, and
wherein the control unit is further configured to, in response to the detected second gesture, control a function of an application corresponding to one handwriting history among the plurality of handwriting histories and controls a function of an application corresponding to another handwriting history among the plurality of handwriting histories.

19. A portable device comprising:
a storage unit configured to store a handwriting history list input to a memo window provided to be superimposed on an application;
a touch screen configured to, when the application is executed again, in response to a handwriting image input on the memo window provided to be superimposed on the application, display a previously input handwriting history list having the handwriting image input through the memo window as a part thereof, and to detect a second gesture that selects at least one handwriting history in the handwriting history list; and
a control unit configured to, in response to the detected second gesture, control a function of the application corresponding to the selected handwriting history.

20. A portable device comprising:
a storage unit configured to store handwriting images input tO a memo window provided to be superimposed on an application;
a touch screen configured to, when the application is executed again, in response to a predetermined first gesture on the memo window provided to be superimposed on the application, display the handwriting images stored in the storage unit on the memo window; and
a control unit configured to automatically control a function of the application corresponding to the displayed handwriting image if the portable terminal does not detect a user input for a predetermined length of time.

21. A non-transitory computer readable storage medium storing an application control program, the program comprising;
displaying an application on the touch screen;
providing a memo window including a handwriting input region to be superimposed on the application;
detecting a first gesture on the memo window;
providing, in response to the detected first gesture, a handwriting history list through the memo window;
detecting a second gesture that selects at least one handwriting history in the handwriting history list; and
controlling, in response to the detected second gesture, a function of the application corresponding to the selected handwriting history.

22. A non-transitory computer readable storage medium storing an application control program, the program comprising:
displaying an application on the touch screen;
providing a memo window which is provided on the touch screen to be superimposed on the application and which includes a handwriting input region;
receiving an input of a handwriting image at the handwriting input region on the memo window;
providing a handwriting history list which has been previously input and has the input handwriting image as a part thereof, through the memo window;
detecting a second gesture that selects at least one handwriting history in the handwriting history list; and
controlling, in response to the detected second gesture, a function of the application corresponding to the selected handwriting history.

23. A non-transitory computer readable storage medium storing an application control program, the program comprising: displaying an application on the touch screen;
providing a memo window which is provided to be superimposed on the application and includes a handwriting input region;
detecting a predetermined first gesture on the memo window;
displaying, in response to the detected first gesture, a handwriting history list through the memo window; and
automatically controlling a function of the application corresponding to the displayed handwriting history if an additional user input is not detected on the touch screen for a predetermined length of time.
